(19) United States
(12) Patent Application Publication
(10) Pub. No.: US 2026/0187487 A1
(43) Pub. Date: Jul. 2, 2026

(54) ISSUE TRACKING PLATFORM WITH KNOWLEDGE BASE DOCUMENT GENERATION SYSTEM USING A GENERATIVE SERVICE

(71) Applicant: Atlassian Pty Ltd., Sydney (AU)

(72) Inventors: Nisha Iyer, Washington, DC (US); Yanjin Kuang, Foster City, CA (US); Kishan Sachdeva, New York, NY (US)

(21) Appl. No.: 19/004,438

(22) Filed: Dec. 29, 2024

(51) Int. Cl. G06N 5/022; G06F 16/34

(52) U.S. Cl. CPC G06N 5/022; G06F 16/345

(57) ABSTRACT

A method of generating content for an issue tracking platform may include defining a set of issue clusters from a body of issues, analysing an issue cluster of the set of issue clusters to determine a resource priority score for a particular product component, and in response to the resource priority score satisfying an evaluation criteria, generating a set of issue summaries from a set of issues. The method may further include generating a knowledge base document generation prompt, the knowledge base document generation prompt including text content extracted from at least a subset of the set of issue summaries, providing the knowledge base document generation prompt to the generative output engine, receiving a second generative response from the generative output engine, and generating at least a portion of a knowledge base document using the second generative response and storing the knowledge base document in the issue tracking platform.

### TECHNICAL FIELD

The present disclosure is generally directed to knowledge base document stores, and more particularly, to systems and methods for automatically identifying a need for knowledge base documents and automatically generating knowledge base documents.

### BACKGROUND

Modern electronic devices facilitate a myriad of uses, both for business and personal endeavors. For example, electronic devices like personal computers, tablets, mobile phones, are used in both business and personal contexts for creating and storing documents, writing computer code, communicating with other individuals (e.g., via email, chat services, voice and video calls, etc.), and the like. Computer-based issue tracking platforms may be used by organizations to facilitate the creation and tracking of issues related to support topics for products, services, software, and the like. Issue tracking platforms may provide knowledge base document for its agents to reference in the service of addressing and resolving issues.

### SUMMARY

A computer-implemented method of generating content for an issue tracking platform may include defining a set of issue clusters from a body of issues, the body of issues hosted by the issue tracking platform, each issue cluster related to a respective product component, analysing an issue cluster of the set of issue clusters to determine a resource priority score for a particular product component, and in response to the resource priority score satisfying an evaluation criteria, generating a set of issue summaries from a set of issues, the set of issues corresponding to the particular product component. Generating an issue summary for a particular issue of the set of issues may include generating an issue summarization prompt for the particular issue, the issue summarization prompt including predetermined first query prompt text and first text content extracted from the particular issue, providing the issue summarization prompt to a generative output engine, receiving a first generative response from the generative output engine, and generating the issue summary for the particular issue using the first generative response. The method may further include generating a knowledge base document generation prompt, the knowledge base document generation prompt including second predetermined query prompt text and second text content extracted from at least a subset of the set of issue summaries, providing the knowledge base document generation prompt to the generative output engine, receiving a second generative response from the generative output engine, and generating at least a portion of a knowledge base document using the second generative response and storing the knowledge base document in the issue tracking platform.

The method may further include, prior to generating the knowledge base document, selecting a group of issue summaries from the set of issue summaries, the selection based at least in part on a semantic similarity of the issue summaries of the group of issue summaries. The second text content extracted from the at least the subset of the set of issue summaries may be extracted from the issue summaries of the group of issue summaries. The selection of the group of issue summaries may be further based on a determination that the issue summaries of the group of issue summaries are not associated with any knowledge base document in the issue tracking platform.

The resource priority score for the product component may be based at least in part on an amount of issues in the issue cluster and an amount of knowledge base documents available in relation to the product component. The resource priority score for the product component may be further based at least in part on an amount of time spent by operators working on issues in the issue cluster.

The first text content extracted from the at least the subset of the set of issues may include a communication message extracted from an issue. The issue may be associated with an identifier of a resource document that contains information relevant to the issue, and the knowledge base document generation prompt may further include third text content extracted from the resource document.

A computer-implemented method of generating content for an issue tracking platform may include defining a set of issue clusters from a body of issues, the body of issues hosted by the issue tracking platform, each issue cluster related to a respective product component, analysing an issue cluster of the set of issue clusters to determine a resource priority score for a product component, the resource priority score based at least in part on an amount of issues in the issue cluster and an amount of knowledge base documents available in relation to the product component, and in response to the resource priority score satisfying an evaluation criteria, generating a set of issue summaries from each of a set of issues, the set of issues corresponding to the product component. The respective product component may be a software feature of a software application. Generating an issue summary for a particular issue of the set of issues may include generating an issue summarization prompt for the particular issue, the issue summarization prompt including predetermined query prompt text and an issue description and one or more communication messages extracted from the particular issue, providing the issue summarization prompt to a generative output engine, receiving a first generative response from the generative output engine, the first generative response including the issue summary, and generating the issue summary for the particular issue using the first generative response. The method may further include selecting a group of issue summaries from the set of issue summaries, the selection based at least in part on a semantic similarity of the issue summaries of the group of issue summaries, and generating a knowledge base document for the product component based on the group of issue summaries. Generating the knowledge base document may include generating a knowledge base document generation prompt, providing the knowledge base document generation prompt to the generative output engine, receiving a second generative response from the generative output engine, and generating at least a portion of the knowledge base document using the second generative response and storing the knowledge base document in the issue tracking platform.

The predetermined query prompt text may be first predetermined query prompt text, and the knowledge base document generation prompt may include second predetermined query prompt text and text content extracted from at least a subset of the group of issue summaries. At least one issue represented by an issue summary of the group of issue summaries may be associated with an identifier of a resource document that contains information relevant to the at least one issue, and the knowledge base document generation prompt may further include third text content extracted from the resource document.

The group of issue summaries may be a first group of issue summaries, the knowledge base document may be a first knowledge base document, and the method may further include selecting a second group of issue summaries from the set of issue summaries, the selection based at least in part on a semantic similarity of the issue summaries of the second group of issue summaries, and generating a second knowledge base document for the product component based on the second group of issue summaries.

Selecting the group of issue summaries from the set of issue summaries may include generating respective content vectors for respective issue summaries of the set of issue summaries, and selecting, as the group of issue summaries, issue summaries with content vectors that satisfy a semantic similarity condition.

The issue cluster of the set of issue clusters may include issues associated with a resolved issue status, and at least a subset of the issues associated with the resolved issue status are not associated with any knowledge base document in the issue tracking platform.

A computer system may include one or more processors, memory, and one or more programs stored in the memory and configured to be executed by the one or more processors and including instructions for analysing an issue cluster of a set of issue clusters of an issue tracking platform to determine a resource priority score for a particular product component, each issue cluster related to a respective product component, in response to the resource priority score satisfying an evaluation criteria, generating a set of issue summaries from a set of issues, the set of issues corresponding to the particular product component, extracting first text content from a resource document identified in at least one issue of the set of issues corresponding to the product component, and extracting second text content from at least a subset of the set of issue summaries. The second text content extracted from the at least the subset of the set of issues may include a communication message extracted from an issue. The one or more programs may further include instructions for generating a knowledge base document generation prompt, the knowledge base document generation prompt including predetermined query prompt text, the first text content extracted from the resource document, and the second text content extracted from the at least the subset of the set of issue summaries, providing the knowledge base document generation prompt to the generative output engine, receiving a generative response from the generative output engine, and generating at least a portion of a knowledge base document using the generative response and storing the knowledge base document in the issue tracking platform.

The one or more programs may further include instructions for, prior to generating the knowledge base document, selecting a group of issue summaries from the set of issue summaries, the selection based at least in part on a semantic similarity of the issue summaries of the group of issue summaries, and the second text content extracted from the at least the subset of the set of issue summaries may be extracted from the issue summaries of the group of issue summaries.

The generative response may be a first generative response, and generating an issue summary for a particular issue of the set of issues may include generating an issue summarization prompt for the particular issue, the issue summarization prompt including third text content extracted from the particular issue, providing the issue summarization prompt to a generative output engine, receiving a second generative response from the generative output engine, and generating the issue summary for the particular issue using the second generative response.

The resource priority score for the product component may be based at least in part on an amount of issues in the issue cluster and an amount of knowledge base documents available in relation to the product component. The resource priority score for the product component may be further based at least in part on an amount of time spent by operators working on issues in the issue cluster.

### BRIEF DESCRIPTION OF THE DRAWINGS

In the drawings:

FIG. 1 depicts an example system in which various features of the present disclosure may be implemented.

FIG. 2 depicts an example system in which a knowledge base document service may interact with an issue tracking platform for knowledge base document generation.

FIG. 3 depicts an example resource priority scoring operation for a knowledge base service.

FIG. 4 depicts an example knowledge base document generation operation.

FIG. 5 depicts example resource priority scores for issue clusters.

FIG. 6A depicts an example issue with issue content.

FIG. 6B depicts an example issue summary of an issue including content generated by a knowledge base document generation service.

FIG. 6C depicts a group of issue summaries from which a knowledge base document may be generated.

FIG. 6D depicts an example knowledge base document generated by a knowledge base document generation service.

FIG. 7 depicts an example process for generating knowledge base documents.

FIG. 8A depicts a simplified diagram of a system, such as described herein that can include and/or may receive input from a generative output engine.

FIG. 8B depicts a functional system diagram of a system that can be used to implement a multiplatform prompt management service.

FIG. 9A depicts a simplified system diagram and data processing pipeline.

FIG. 9B depicts a system providing multiplatform prompt management as a service.

FIG. 10 shows a sample electrical block diagram of an electronic device that may perform the operations described herein.

While the invention as claimed is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION OF THE EMBODIMENTS

In the following description numerous specific details are set forth in order to provide a thorough understanding of the claimed invention. It will be apparent, however, that the claimed invention may be practiced without these specific details. In some instances, well-known structures and devices are shown in block diagram form in order to avoid unnecessary obscuring.

The present disclosure is generally directed to issue tracking systems that are associated with knowledge base document systems. For example, issue tracking systems may facilitate the generation and management of issues or tickets in a variety of contexts. As a particular example, service agents may use an issue tracking system to generate and manage issues for technical support events. Issues may be associated with information and a workflow. The information may include any information about the event for which the issue is created (e.g., a description of the event or problem, communications between a support agent and a user, information about how the issue was resolved, etc.). The workflow may represent a state of the issue, such as pending, assigned, in process, and resolved or completed. Issues may relate to (and be generated for the purposes of resolving) support topics that are encountered by users of a product or service that is supported by the issue tracking system.

As used herein, an issue may generally refer to a data record, data structure, or other identifiable set of data that pertains to a support topic, and a support topic may refer to the particular problem or question for which support was sought. As one specific example, a support topic may correspond to a user encountering a problem creating a document in a software system. The user may contact a support agent about the support topic, and the agent may create an issue in relation to the support topic, where the issue includes information about the support topic, the status of the issue, communications between the user and the agent, a description of how the issue was resolved, and the like. Support topics may generally relate to a problem or question that may be encountered by multiple users, and does not necessarily correspond to a single instance of a problem or question. Stated another way, multiple users may encounter a support topic and contact a technical support service for assistance with the support topic, and knowledge base documents may be generated to aid in the future resolution of the support topic by other agents.

Where an issue tracking system is used for technical support, or other contexts in which issues may be associated with an agent or service personnel aiding in the resolution of a support topic, an agent may consult resources such as knowledge base documents, webpages, manuals, product specifications and documentation, source code (and source code comments), and the like. In some cases, a knowledge base may be curated for providing highly specific and targeted information on how to resolve certain types of technical support topics, especially for subjects on which a technical support service receives repeated inquiries. For example, if users repeatedly contact a support service with problems relating to a particular product component (e.g., a component or feature of a software product), it may be advantageous for a service agent to generate a knowledge base document outlining how that problem can be resolved. Other agents may then access the knowledge base document when they encounter a user with the same or similar problem.

In some cases, it may be cumbersome and inconvenient to generate knowledge base documents manually, as an agent needs to devote significant time to drafting a document that is complete, accurate, and helpful. Further, in many cases, it can be difficult to determine what subject areas would most benefit from having new knowledge base documents created. For example, in large-scale issue tracking systems, there may be hundreds or thousands of different topics or questions that the agents are required to address. In such cases, it may be difficult for any individual agent to recognize whether any particular topic, product component, or support topic would benefit from a new knowledge base document.

Accordingly, described herein is a knowledge base document service that uses generative services to automatically identify subject areas that are in need of additional knowledge base documents (e.g., to aid in the rapid resolution of issues), and to automatically generate such knowledge base documents. By employing generative services, this system may result in faster identification of priority subject areas and generation of knowledge base documents for those subject areas, without taking agents away from their primary task of working with users to provide support and resolve issues.

As described herein, the knowledge base document service (or simply knowledge base service) may analyze issues within the issue tracking system to determine resource priority scores for various product components, and may select a product component for which to generate knowledge base documents based on the scores. More particularly, resource priority scores generally represent the extent to which a particular product component needs knowledge base documents. The resource priority scores may be based on various factors, such as an amount of issues being generated for that product component, and the amount of issues that have been resolved without reference to an existing knowledge base document. Thus, a high resource priority score may indicate that many agents are having to resolve a particular type of support topic without a targeted knowledge base document for that particular subject.

Once a particular product component (and corresponding set of issues) is selected for generating a knowledge base document, the knowledge base service may use an issue summarization service to generate summaries of the issues that relate to that product component. By generating issue summaries (e.g., with a generative service), salient information from the issue may be condensed and presented in a uniform format, which may aid in further processing operations, as described herein.

The issue summaries may in some cases be further analyzed to identify, within a cluster of issues that relate to the particular product component, issues that likely relate to a same problem and a same solution. For example, a grouping engine may analyze the issue summaries and identify a group of issues with high semantic similarity score. This way, the knowledge base service may ensure that the knowledge base document that it generates is focused on a particular solution, and further that the issue summaries that are used as source documents for the knowledge base document each relate to the same support topic and/or a same or similar resolution.

Once the group of issue summaries directed to the same support topic is identified, a knowledge base document generation engine may generate, with a generative service, a knowledge base document based on the group of issue summaries. Thus, the knowledge base document is automatically generated based on actual resolutions to issues that were memorialized by an agent of the issue tracking system. This technique may be repeated to repeatedly or continuously identify subject areas where a knowledge base is deficient or could benefit from additional knowledge base documents, and automatically generate those documents to populate the knowledge base.

### SCALABLE NETWORK ARCHITECTURE FOR AUTOMATIC CONTENT GENERATION

As described herein, the knowledge base service may use content generation tools for various aspects of the knowledge base service, including, without limitation, generating issue summaries, generating knowledge base document from issue summaries, and the like. More specifically, to generate content, systems and methods described herein can leverage a scalable network architecture that includes an input request queue, a normalization (and/or redaction) preconditioning processing pipeline, an optional secondary request queue, and a set of one or more purpose-configured large language model instances (LLMs) and/or other trained classifiers or natural language processors.

Collectively, such engines or natural language processors may be referred to herein as “generative output engines.” A system incorporating a generative output engine can be referred to as a “generative output system” or a “generative output platform.” Broadly, the term “generative output engine” may be used to refer to any combination of computing resources that cooperate to instantiate an instance of software (an “engine”) in turn configured to receive a string prompt as input and configured to provide, as deterministic or pseudo-deterministic output, generated text which may include words, phrases, paragraphs and so on in at least one of (1) one or more human languages, (2) code complying with a particular language syntax, (3) pseudocode conveying in human-readable syntax an algorithmic process, or (4) structured data conforming to a known data storage protocol or format, or combinations thereof.

The string prompt (or “input prompt” or simply “prompt”) received as input by a generative output engine can be any suitably formatted string of characters, in any natural language or text encoding. In some cases, the prompt includes predetermined query prompt text. The predetermined query prompt text may include one of a number of predetermined phrases that provide instructions to a generative output engine including, without limitation, formatting instructions regarding a preferred length of the response, instructions regarding the tone of the response, instructions regarding the format of the response, instructions regarding prohibited words or phrases to be included in the response, context information that may be specific to the tenant or to a platform, and other predetermined instructions. In some cases, the predetermined query prompt text includes a set of example input-output data pairs that may be used to provide example formatting, tone, and style of the expected generative response. In some cases, the predetermined query prompt text includes special instructions to help prevent hallucinations in the response or other potential inaccuracies. The predetermined query prompt text may also be pre-populated with exemplary content, extracted from a content item, representing an ideal or reference output, which may reflect a style and tone of the tenant or content hosted on the platform. The prompt may also include text content extracted from various sources, as described herein.

In some examples, prompts can include non-linguistic content, such as media content (e.g., image attachments, audiovisual attachments, files, links to other content, and so on) or source or pseudocode. In some cases, a prompt can include structured data such as tables, markdown, JSON formatted data, XML formatted data, and the like. A single prompt can include natural language portions, structured data portions, formatted portions, portions with embedded media (e.g., encoded as base64 strings, compressed files, byte streams, or the like) pseudocode portions, or any other suitable combination thereof.

The string prompt may include letters, numbers, whitespace, punctuation, and in some cases formatting. Similarly, the generative output of a generative output engine as described herein can be formatted/encoded according to any suitable encoding (e.g., ISO, Unicode, ASCII as examples).

In these embodiments, a user may provide input to a software platform coupled to a network architecture as described herein. The user input may be in the form of interaction with a graphical user interface affordance (e.g., button or other UI element), or may be in the form of plain text. In some cases, the user input may be provided as typed string input provided to a command prompt triggered by a preceding user input. Many of the examples described herein are directed to an interface that includes a generative interface panel having an input region that can receive commands, references to content, links, and other input, at least a portion of which is provided as natural language text.

In some examples, the user may engage with a button in a UI that causes the generative interface panel or a command prompt input box to be rendered, into which the user can begin typing a command. In other cases, the user may position a cursor within an editable text field and the user may type a character or trigger sequence of characters that cause a command-receptive user interface element to be rendered. As one example, a text editor may support slash commands—after the user types a slash character, any text input after the slash character can be considered as a command to instruct the underlying system to perform a task.

Regardless of how a software platform user interface is instrumented to receive user input, the user may provide an input that includes a string of text including a natural language request or instruction (e.g., a prompt). The prompt may be provided as input to an input queue including other requests from other users or other software platforms. Once the prompt is popped from the queue, it may be normalized and/or preconditioned by a preconditioning service. The preconditioning service may be provided by one or more registered plugins that are selected in accordance with an analysis of the input and/or context of the current session.

The preconditioning service can, without limitation: append additional context to the user's raw input; may insert the user's raw input into a template prompt selected from a set of prompts; replace ambiguous references in the user's input with specific references (e.g., replace user-directed pronouns with user IDs, replace @mentions with user IDs, and so on); correct spelling or grammar; translate the user input to another language; or perform other operations. Thereafter, optionally, the modified/supplemented/hydrated user input can be provided as input to a secondary queue that meters and orders requests from one or more software platforms to a generative output system, such as described herein. The generative output system receives, as input, a modified prompt and provides a continuation of that prompt as output which can be directed to an appropriate recipient, such as the graphical user interface operated by the user that initiated the request or such as a separate platform. Many configurations and constructions are possible.

### LARGE LANGUAGE MODELS

An example of a generative output engine of a generative output system as described herein may be a large language model (LLM). An LLM may include a neural network specifically trained to determine probabilistic relationships between members of a sequence of lexical elements, characters, strings or tags (e.g., words, parts of speech, or other subparts of a string), the sequence presumed to conform to rules and structure of one or more natural languages and/or the syntax, convention, and structure of a particular programming language and/or the rules or convention of a data structuring format (e.g., JSON, XML, HTML, Markdown, and the like).

More simply, an LLM is configured to determine what word, phrase, number, whitespace, nonalphanumeric character, or punctuation is most statistically likely to be next in a sequence, given the context of the sequence itself. The sequence may be initialized by the input prompt provided to the LLM. In this manner, output of an LLM is a continuation of the sequence of words, characters, numbers, whitespace, and formatting provided as the prompt input to the LLM.

To determine probabilistic relationships between different lexical elements (as used herein, “lexical elements” may be a collective noun phrase referencing words, characters, numbers, whitespace, formatting, and the like), an LLM is trained against as large of a body of text as possible, comparing the frequency with which particular words appear within N distance of one another. The distance N may be referred to in some examples as the token depth or contextual depth of the LLM.

In many cases, word and phrase lexical elements may be lemmatized, part of speech tagged, or tokenized in another manner as a pretraining normalization step, but this is not required of all embodiments. An LLM is typically trained on natural language text in respect of multiple domains, subjects, contexts, and so on; typical commercial LLMs are trained against substantially all available internet text or written content available (e.g., printed publications, source repositories, and the like). Training data may occupy petabytes of storage space in some examples.

As an LLM is trained to determine which lexical elements are most likely to follow a preceding lexical element or set of lexical elements, an LLM must be provided with a prompt that invites continuation. In general, the more specific a prompt is, the fewer possible continuations of the prompt exist. For example, the grammatically incomplete prompt of “can a computer” invites completion, but also represents an initial phrase that can begin a near limitless number of probabilistically reasonable next words, phrases, punctuation and whitespace. A generative output engine may not provide a contextually interesting or useful response to such an input prompt, effectively choosing a continuation at random from a set of generated continuations of the grammatically incomplete prompt.

By contrast, a narrower prompt that invites continuation may be “can a computer supplied with a 30 W power supply consume 60 W of power?” A large number of possible correct phrasings of a continuation of this example prompt exist, but the number is significantly smaller than the preceding example, and a suitable continuation can be selected or generated using a number of techniques. In many cases, a continuation of an input prompt may be referred to more generally as “generated text” or “generated output” provided by a generative output engine as described herein.

Fundamentally all written natural languages, syntaxes, and well-defined data structuring formats can be probabilistically modeled by an LLM trained by a suitable training dataset that is both sufficiently large and sufficiently relevant to the language, syntax, or data structuring format desired for automatic content/output generation. In addition, because punctuation and whitespace can serve as a portion of training data, the generated output of an LLM can be expected to be grammatically and syntactically correct, as well as being punctuated appropriately. As a result, generated output can take many suitable forms and styles, if appropriate in respect of an input prompt.

Further, as noted above in addition to natural language, LLMs can be trained on source code in various highly structured languages or programming environments and/or on data sets that are structured in compliance with a particular data structuring format (e.g., markdown, table data, CSV data, TSV data, XML, HTML, JSON, and so on).

As with natural language, data structuring and serialization formats (e.g., JSON, XML, and so on) and high-order programming languages (e.g., C, C++, Python, Go, Ruby, JavaScript, Swift, and so on) include specific lexical rules, punctuation conventions, whitespace placement, and so on. In view of this similarity with natural language, an LLM generated output can, in response to suitable prompts, include source code in a language indicated or implied by that prompt. For example, a prompt of “what is the syntax for a while loop in C and how does it work” may be continued by an LLM by providing, in addition to an explanation in natural language, a C++ compliant example of a while loop pattern. In some cases, the continuation/generative output may include format tags/keys such that when the output is rendered in a user interface, the example C++ code that forms a part of the response is presented with appropriate syntax highlighting and formatting.

As noted above, in addition to source code, generative output of an LLM or other generative output engine type can include and/or may be used for document structuring or data structuring, such as by inserting format tags (e.g., markdown). In other cases, whitespace may be inserted, such as paragraph breaks, page breaks, or section breaks. In yet other examples, a single document may be segmented into multiple documents to support improved legibility. In other cases, an LLM generated output may insert cross-links to other content, such as other documents, other software platforms, or external resources such as websites.

In yet further examples, an LLM generated output can convert static content to dynamic content. In one example, a user-generated document can include a string that contextually references another software platform. For example, a documentation platform document may include the string “this document corresponds to project ID 123456, status of which is pending.” In this example, a suitable LLM prompt may be provided that causes the LLM to determine an association between the documentation platform and a project management platform based on the reference to “project ID 123456.”

In response to this recognized context, the LLM can wrap the substring “project ID 123456” in anchor tags with an embedded URL in HTML-compliant syntax that links directly to project 123456 in the project management platform, such as: “<a href=‘https://example link/123456>project123456</a>”. In addition, the LLM may be configured to replace the substring “pending” with a real-time updating token associated with an API call to the project management system. In this manner, the LLM converts a static string within the document management system into richer content that facilitates convenient and automatic cross-linking between software products, and may result in additional downstream positive effects on performance of indexing and search systems.

In further embodiments, the LLM may be configured to generate as a portion of the same generated output a body of an API call to the project management system that creates a link back or other association to the documentation platform. In this manner, the LLM facilitates bidirectional content enrichment by adding links to each software platform.

More generally, a continuation produced as output by an LLM can include not only text, source code, pseudocode, structured data, and/or cross-links to other platforms, but it also may be formatted in a manner that includes titles, emphasis, paragraph breaks, section breaks, code sections, quote sections, cross-links to external resources, inline images, graphics, table-backed graphics, and so on.

In yet further examples, static data may be generated and/or formatted in a particular manner in a generative output. For example, a valid generative output can include JSON-formatted data, XML-formatted data, HTML-formatted data, markdown table formatted data, comma-separated value data, tab-separated value data, or any other suitable data structuring defined by a data serialization format.

### TRANSFORMER ARCHITECTURE

In many constructions, an LLM may be implemented with a transformer architecture. In other cases, traditional encoder/decoder models may be appropriate. In transformer topologies, a suitable self-attention or intra-attention mechanism may be used to inform both training and generative output. A number of attention mechanisms, including self-attention mechanisms, may be suitable.

In response to an input prompt that at least contextually invites continuation, a transformer-architected LLM may provide probabilistic, generated, output informed by one or more self-attention signals. Even still, the LLM or a system coupled to an output thereof may be required to select one of many possible generated outputs/continuations. In some cases, continuations may be misaligned in respect of conventional ethics. For example, a continuation of a prompt requesting information to build a weapon may be inappropriate. Similarly, a continuation of a prompt requesting to write code that exploits a vulnerability in software may be inappropriate. Similarly, a continuation requesting drafting of libelous content in respect of a real person may be inappropriate. In more innocuous cases, continuations of an LLM may adopt an inappropriate tone or may include offensive language.

In view of the foregoing, more generally, a trained LLM may provide output that continues an input prompt, but in some cases, that output may be inappropriate. To account for these and other limitations of source-agnostic trained LLMs, fine tuning may be performed to align output of the LLM with values and standards appropriate to a particular use case. In many cases, reinforcement training may be used. In particular, output of an untuned LLM can be provided to a human reviewer for evaluation.

The human reviewer can provide feedback to inform further training of the LLM, such as by filling out a brief survey indicating whether a particular generated output: suitably continues the input prompt; contains offensive language or tone; provides a continuation misaligned with typical human values; and so on.

This reinforcement training by human feedback can reinforce high quality, tone neutral, continuations provided by the LLM (e.g., positive feedback corresponds to positive reward) while simultaneously disincentivizing the LLM to produce offensive continuations (e.g., negative feedback corresponds to negative reward). In this manner, an LLM can be fine-tuned to preferentially produce desirable, inoffensive, generative output which, as noted above, can be in the form of natural language and/or source code.

### GENERATIVE OUTPUT ENGINES & GENERATIVE OUTPUT SYSTEMS

Independent of training and/or configuration of one or more underlying engines (typically instantiated as software), it may be appreciated that generally and broadly, a generative output system as described herein can include a physical processor or an allocation of the capacity thereof (shared with other processes, such as operating system processes and the like), a physical memory or an allocation thereof, and a network interface. The physical memory can include datastores, working memory portions, storage portions, and the like. Storage portions of the memory can include executable instructions that, when executed by the processor, cause the processor to (with assistance of working memory) instantiate an instance of a generative output application, also referred to herein as a generative output service.

The generative output application can be configured to expose one or more API endpoints, such as for configuration or for receiving input prompts. The generative output application can be further configured to provide generated text output to one or more subscribers or API clients. Many suitable interfaces can be configured to provide input to and receive output from a generative output application, as described herein.

For simplicity of description, the embodiments that follow reference generative output engines and generative output applications configured to exchange structured data with one or more clients, such as the input and output queues described above. The structured data can be formatted according to any suitable format, such as JSON or XML. The structured data can include attributes or key-value pairs that identify or correspond to subparts of a single response from the generative output engine.

For example, a request to the generative output engine from a client can include attribute fields such as, but not limited to: requester client ID; requester authentication tokens or other credentials; requester authorization tokens or other credentials; requester username; requester tenant ID or credentials; API key(s) for access to the generative output engine; request timestamp; generative output generation time; request prompt; string format form generated output; response types requested (e.g., paragraph, numeric, or the like); callback functions or addresses; generative engine ID; data fields; supplemental content; reference corpuses (e.g., additional training or contextual information/data) and so on. A simple example request may be JSON formatted, and may be:

```
{
  “prompt” : “Generate five words of placeholder text in the
English language.”,
  “API_KEY: “hx-Y5u4zx3kaF67AzkXK1hC”,
    “user_token”: “PkcLe7Co2G-50AoIVojGJ”
}
```

Similarly, a response from the generative output engine can include attribute fields such as, but not limited to: requester client ID; requester authentication tokens or other credentials; requester authorization tokens or other credentials; requester username; requester role; request timestamp; generative output generation time; request prompt; generative output formatted as a string; and so on. For example, a simple response to the preceding request may be JSON formatted and may be:

```
{
  “response” : “Hello world text goes here.”,
  “generation_time_ms” : 2
}
```

In some embodiments, a prompt provided as input to a generative output engine can be engineered from user input. For example, in some cases, a user input can be inserted into an engineered template prompt that itself is stored in a database. For example, an engineered prompt template can include one or more fields into which user input portions thereof can be inserted. In some cases, an engineered prompt template can include contextual information that narrows the scope of the prompt, increasing the specificity thereof.

For example, some engineered prompt templates can include example input/output format cues or requests that define for a generative output engine, as described herein, how an input format is structured and/or how output should be provided by the generative output engine.

### PROMPT PRE-CONFIGURATION, TEMPLATIZING, & ENGINEERING

As noted above, a prompt received from a user can be preconditioned and/or parsed to extract certain content therefrom. The extracted content can be used to inform selection of a particular engineered prompt template from a database of engineered prompt templates. Once the selected prompt template is selected, the extracted content can be inserted into the template to generate a populated engineered prompt template that, in turn, can be provided as input to a generative output engine as described herein. Content extraction, prompt configuration, and prompt selection may be performed by a processing plugin that is registered or otherwise available to a generative service.

In many cases, a particular engineered prompt template can be selected based on a desired task for which output of the generative output engine may be useful to assist. For example, if a user requires a summary of a particular document, the user input prompt may be a text string comprising the phrase “generate a summary of this page.” A software instance configured for prompt preconditioning—which may be referred to as a “preconditioning software instance,” “prompt preconditioning software instance,” “processing plugin,” or “plugin”—may perform one or more substitutions of terms or words in this input phrase, such as replacing the demonstrative pronoun phrase “this page” with an unambiguous unique page ID. In this example, preconditioning software instance can provide an output of “generate a summary of the page with id 123456” which in turn can be provided as input to a generative output engine.

In an extension of this example, the preconditioning software instance can be further configured to insert one or more additional contextual terms or phrases into the user input. In some cases, the inserted content can be inserted at a grammatically appropriate location within the input phrase or, in other cases, may be appended or prepended as separate sentences.

For example, in an embodiment, the preconditioning software instance can insert a phrase that adds contextual information describing the user making the initial input and request. In this example, output of the prompt preconditioning instance may be “generate a summary of the page with id 123456 with phrasing and detail appropriate for the role of user 76543.” In this example, if the user requesting the summary is an engineer, a different summary may be provided than if the user requesting the summary is a manager or executive.

In yet other examples, prompt preconditioning may be further contextualized before a given prompt is provided as input to a generative output engine. Additional information that can be added to a prompt (sometimes referred to as “contextual information”, “prompt context” or “supplemental prompt information”) can include but may not be limited to: user names; user roles; user tenure (e.g., new users may benefit from more detailed summaries or other generative content than long-term users); user projects; user groups; user teams; user tasks; user reports; tasks, assignments, or projects of a user's reports, and so on. For example, in some embodiments, a user-input prompt may be “generate a table of all my tasks for the next two weeks, and insert the table into my home page in my personal space.” In this example, a preconditioning instance can replace “my” with a reference to the user's ID or another unambiguous identifier associated with the user. Similarly, the “home page in my personal space” can be replaced, contextually, with a page identifier that corresponds to that user's personal space and the page that serves as the homepage thereof. Additionally, the preconditioning instance can replace the referenced time window in the raw input prompt based on the current date and based on a calculated date two weeks in the future. With these two modifications, the modified input prompt may be “generate a table of the tasks assigned to User 1234 dating from Jan. 1, 2023-Jan. 14, 2023 (inclusive), and insert the generated table into page 567.” In these embodiments, the preconditioning instance may be configured to access session information to determine the user ID.

In other cases, the preconditioning service may be configured to structure and submit a query to an active directory service or user graph service to determine user information and/or relationships to other users. For example, a prompt of “summarize the edits to this page made by my team since I last visited this page” could determine the user's ID, team members with close connections to that user based on a user graph, determine that the user last visited the page three weeks prior, and filter attribution of edits within the last three weeks to the current page ID based on those team members. With these modifications, the prompt provided to the generative output engine may be:

```
{
  “raw_prompt” : summarize the edits to this page made by
my team since I last visited this page”,
  “modified_prompt” : “Generate a summary of each
paragraph tagged with an editId attribute matching editId=1,
editId=51, editId=165, editId=99 within the following HTML-
formatted content: [HTML-formatted content of the page].”
}
```

Similarly, the preconditioning service may utilize a project graph, issue graph, or other data structure that is generated using edges or relationships between system objects that are determined based on express object dependencies, user event histories of interactions with related objects, or other system activity indicating relationships between system objects. The graphs may also associate system objects with particular users or user identifiers based on interaction logs or event histories.

Generally, a preconditioning service, as described herein, can be configured to access and append significant contextual information describing a user and/or users associated with the user submitting a particular request, the user's role in a particular organization, the user's technical expertise, the user's computing hardware (e.g., different response formats may be suitable and/or selectable based on user equipment), and so on.

In further implementations of this example, a snippet of prompt text can be selected from a snippet dictionary or table that further defines how the requested table should be formatted as output by the generative output engine. For example, a snippet selected from a database and appended to the modified prompt may be:

{
“snippet123_table_from_tasks” : “The table should be
formatted as a three-column table with multiple rows. The leftmost
column should be titled ‘Title’ and the corresponding content of
each row of this column should be the title attribute of a task. The
middle column should be titled ‘Created Date’ and the
corresponding content of each row of this column should be the
creation date of the task. The rightmost column should be titled
‘Status’ and the corresponding content of each row of this column
should be the status attribute of the selected task.”
}

The foregoing examples of modifications and supplements to user input prompt are not exhaustive. Other modifications are possible. In one embodiment, the user input of “generate a table of all my tasks for the next two weeks” may be converted, supplemented, modified, and/or otherwise preconditioned to:

{
“modified_prompt” : “Find all tasks assigned to User 1234
dating from Jan 01, 2023 - Jan 14, 2023 (inclusive). Create a table
in which each found task corresponds to a respective row of that
table. The table should be formatted as a markdown table, in plain
text, with three columns. The leftmost column should be titled
‘Title’ and the corresponding content of each row of this column
should be the title attribute of a respective task. The middle column
should be titled ‘Created Date’ and the corresponding content of
each row of this column should be the creation date of the
respective task. The rightmost column should be titled ‘Status’ and
the corresponding content of each row of this column should be the
status attribute of the respective task.”
}

The operations of modifying a user input into a descriptive paragraph or set of paragraphs that further contextualize the input may be referred to as “prompt engineering.” In many embodiments, a preconditioning software instance may serve as a portion of a prompt engineering service configured to receive user input and to enrich, supplement, and/or otherwise hydrate a raw user input into a detailed prompt that may be provided as input to a generative output engine as described herein.

In other embodiments, a prompt engineering service may be configured to append bulk text to a prompt, such as document content in need of summarization or contextualization.

In other cases, a prompt engineering service can be configured to recursively and/or iteratively leverage output from a generative output engine in a chain of prompts and responses. For example, a prompt may call for a summary of all documents related to a particular project. In this case, a prompt engineering service may coordinate and/or orchestrate several requests to a generative output engine to summarize a first document, a second document, and a third document, and then generate an aggregate response of each of the three summarized documents.

In yet other examples, staging of requests may be useful for other purposes.

### AUTHENTICATION & AUTHORIZATION

Still further embodiments reference systems and methods for maintaining compliance with permissions, authentication, and authorization within a software environment. For example, in some embodiments, a prompt engineering service can be configured to append to a prompt one or more contextualizing phrases that direct a generative output engine to draw insight from only a particular subset of content to which the requesting user has authorization to access.

In some cases, a prompt engineering service may be configured to proactively determine what data or database calls may be required by a particular user input. If data required to service the user's request is not authorized to be accessed by the user, that data and/or references to it may be restricted/redacted/removed from the prompt before the prompt is submitted as input to a generative output engine. The prompt engineering service may access a user profile of the respective user and identify content having access permissions that are consistent with a role, permissions profile, or other aspect of the user profile. The prompt engineering service may also verify or validate links that are referenced in the prompt from which prompt content is extracted before the prompt is provided to the generative output engine. Specifically, the prompt engineering service or another software instance can be configured to iterate through each link to determine (1) whether the link is valid, and (2) whether the requesting user has permission and authorization to view content at the link. If either test fails, the prompt generation may be interrupted or canceled and/or an error message may be displayed to the user.

In other embodiments, a prompt engineering service may be configured to request that the generative output engine append citations (e.g., back links) to each page or source from which information in a generative response was based. In these examples and as described above, the prompt engineering service or another software instance can be configured to iterate through each link to determine (1) whether the link is valid, and (2) whether the requesting user has permission and authorization to view content at the link. If either test fails, the response from the generative output engine may be rejected and/or a new prompt may be generated specifically including an exclusion request such as “Exclude and ignore all content at XYZ.url.”

In yet other examples, a prompt engineering service may be configured to classify a user input into one of a number of classes of requests. Different classes of requests may be associated with different permissions handling techniques. For example, a class of request that requires a generative output engine to resource from multiple pages may have different authorization enforcement mechanisms or workflows than a class of request that requires a generative output engine to resource from only a single location.

These foregoing examples are not exhaustive. Many suitable techniques for managing permissions in a prompt engineering service and generative output engine system may be possible in view of the embodiments described herein. More generally, as noted above, a generative output engine may be a portion of a larger network and communications architecture as described herein. This network can include input queues, prompt constructors, engine selection logical elements, request routing appliances, authentication handlers and so on.

### COLLABORATION PLATFORMS INTEGRATED WITH GENERATIVE OUTPUT SYSTEMS

In particular, embodiments described herein are focused to leveraging generative output engines to produce content in a software platform used for collaboration between multiple users, such as documentation tools, issue tracking systems, project management systems, information technology service management systems, ticketing systems, repository systems, telecommunications systems, messaging systems, and the like, each of which may define different environments in which content can be generated by users of those systems. For example, a documentation system may define an environment in which users of the documentation system can leverage a user interface of a frontend of the system to generate documentation in respect of a project, product, process, or goal. For example, a software development team may use a documentation system to document features and functionality of the software product. In other cases, the development team may use the documentation system to capture meeting notes, track project goals, and outline internal best practices.

Other software platforms store, collect, and present different information in different ways. For example, an issue tracking system may be used to assign work within an organization and/or to track completion of work, a ticketing system may be used to track compliance with service level agreements, and so on. Any one of these software platforms or platform types can be communicably coupled to a generative output engine, as described herein, in order to automatically generate structured or unstructured content within environments defined by those systems. For example, a documentation system can leverage a generative output engine to, without limitation: summarize individual documents; summarize portions of documents; summarize multiple selected documents; generate document templates; generate document section templates; generate suggestions for cross-links to other documents or platforms; generate suggestions for adding detail or improving conciseness for particular document sections; and so on.

More broadly, it may be appreciated that a single organization may be a tenant of multiple software platforms, of different software platform types. Generally and broadly, regardless of configuration or purpose, a software platform that can serve as source information for operation of a generative output engine as described herein may include a frontend and a backend configured to communicably couple over a computing network (which may include the open Internet) to exchange computer-readable structured data.

The frontend may be a first instance of software executing on a client device, such as a desktop computer, laptop computer, tablet computer, or handheld computer (e.g., mobile phone). The backend may be a second instance of software executing over a processor allocation and memory allocation of a virtual or physical computer architecture. In many cases, although not required, the backend may support multiple tenancies. In such examples, a software platform may be referred to as a multitenant software platform.

For simplicity of description, the multitenant embodiments presented herein reference software platforms from the perspective of a single common tenant. For example, an organization may secure a tenancy of multiple discrete software platforms, providing access for one or more employees to each of the software platforms. Although other organizations may have also secured tenancies of the same software platforms which may instantiate one or more backends that serve multiple tenants, it is appreciated that data of each organization is siloed, encrypted, and inaccessible to, other tenants of the same platform.

In many embodiments, the frontend and backend of a software platform - multitenant or otherwise - as described herein are not collocated, and communicate over a large area and/or wide area network by leveraging one or more networking protocols, but this is not required of all implementations.

A frontend of a software platform as described herein may be configured to render a graphical user interface at a client device that instantiates frontend software. As a result of this architecture, the graphical user interface of the frontend can receive inputs from a user of the client device, which, in turn, can be formatted by the frontend into computer-readable structured data suitable for transmission to the backend for storage, transformation, and later retrieval. One example architecture includes a graphical user interface rendered in a browser executing on the client device. In other cases, a frontend may be a native application executing on a client device. Regardless of architecture, it may be appreciated that generally and broadly a frontend of a software platform as described herein is configured to render a graphical user interface to receive inputs from a user of the software platform and to provide outputs to the user of the software platform.

Input to a frontend of a software platform by a user of a client device within an organization may be referred to herein as “organization-owned” content. With respect to a particular software platform, such input may be referred to as “tenant-owned” or “platform-specific” content. In this manner, a single organization's owned content can include multiple buckets of platform-specific content.

Herein, the phrases “tenant-owned content” and “platform-specific content” may be used to refer to any and all content, data, metadata, or other information regardless of form or format that is authored, developed, created, or otherwise added by, edited by, or otherwise provided for the benefit of, a user or tenant of a multitenant software platform. In many embodiments, as noted above, tenant-owned content may be stored, transmitted, and/or formatted for display by a frontend of a software platform as structured data. In particular structured data that includes tenant-owned content may be referred to herein as a “data object” or a “tenant-specific data object.”

In a more simple, non-limiting phrasing, any software platform described herein can be configured to store one or more data objects in any form or format unique to that platform. Any data object of any platform may include one or more attributes and/or properties or individual data items that, in turn, include tenant-owned content input by a user.

Example tenant-owned content can include personal data, private data, health information, personally-identifying information, business information, trade secret content, copyrighted content or information, restricted access information, research and development information, classified information, mutually-owned information (e.g., with a third-party or government entity), or any other information, multi-media, or data. In many examples, although not required, tenant-owned content or, more generally, organization-owned content may include information that is classified in some manner, according to some procedure, protocol, or jurisdiction-specific regulation.

In particular, the embodiments and architectures described herein can be leveraged by a provider of multitenant software and, in particular, by a provider of suites of multitenant software platforms, each platform being configured for a different particular purpose. Herein, providers of systems or suites of multitenant software platforms are referred to as “multiplatform service providers.” Generally, customers/clients of a multiplatform service provider are typically tenants of multiple platforms provided by a given multiplatform service provider. For example, a single organization (a client of a multiplatform service provider) may be a tenant of a messaging platform and, separately, a tenant of a project management platform.

The organization can create and/or purchase user accounts for its employees so that each employee has access to both messaging and project management functionality. In some cases, the organization may limit seats in each tenancy of each platform so that only certain users have access to messaging functionality and only certain users have access to project management functionality; the organization can exercise discretion as to which users have access to either or both tenancies.

In another example, a multiplatform service provider can host a suite of collaboration tools. For example, a multiplatform service provider may host, for its clients, a multitenant issue tracking system, a multitenant code repository service, and a multitenant documentation service. In this example, an organization that is a customer/client of the service provider may be a tenant of each of the issue tracking system, the code repository service, and the documentation service.

As with preceding examples, the organization can create and/or purchase user accounts for its employees, so that certain selected employees have access to one or more of issue tracking functionality, documentation functionality, and code repository functionality.

In this example and others, a system may leverage multiple collaboration tools to advance individual projects or goals. For example, for a single software development project, a software development team may use (1) a code repository to store project code, executables, and/or static assets, (2) a documentation service to maintain documentation related to the software development project, (3) an issue tracking system to track assignment and progression of work, and (4) a messaging service to exchange information directly between team members.

However, as organizations grow, as project teams become larger, and/or as software platforms mature and add features or adjust user interaction paradigms over time, using multiple software platforms can become inefficient for both individuals and organizations. To counteract these effects, many organizations define internal policies that employees are required to follow to maintain data freshness across the various platforms used by an organization.

For example, when a developer submits a new pull request to a repository service, that developer may also be required by the organization to (1) update a description of the pull request in a documentation service, (2) change a project status in a project management application, and/or (3) close a ticket in a ticketing or issue tracking system relating to the pull request. In many cases, updating and interacting with multiple platforms on a regular and repeating basis is both frustrating and time consuming for both individuals and organizations, especially if the completion of work of one user is dependent upon completion of work of another user.

Some solutions to these and related problems often introduce further issues and complexity. For example, many software platforms include an in-built automation engine that can expedite performance of work within that software platform. In many cases, however, users of a software platform with an in-built automation engine may not be familiar with the features of the automation engine, nor may those users understand how to access, much less efficiently utilize, that automation engine. For example, in many cases, accessing in-built automation engines of a software platform requires diving deep into a settings or options menu, which may be difficult to find.

Other solutions involve an inter-platform bridge software that allows data from one platform to be accessed by another platform. Typically, such bridging software is referred to as an “integration” between platforms. An integration between different platforms may allow content, features, and/or functionality of one platform to be used in another platform.

For example, a multiplatform service provider may host an issue tracking system and a documentation system. The provider may also supply an integration that allows issue tracking information and data objects to be shown, accessed, and/or displayed from within the documentation system. In this example, the integration itself needs to be separately maintained in order to be compliant with an organization's data sharing and/or permissions policies. More specifically, an integration must ensure that authenticated users of the documentation system that view a page that references information stored by the issue tracking system are also authorized to view that information by the issue tracking system.

Phrased in a more general way, an architecture that includes one or more integrations between tenancies of different software platforms requires multiple permissions requests that may be forwarded to different systems, each of which may exhibit different latencies, and have different response formats, and so on. More broadly, some system architectures with integrations between software platforms necessarily require numerous network calls and requests, occupying bandwidth and computational resources at both software platforms and at the integration itself, to simply share and request information and service requests for information by and between the different software platforms. This architectural complexity necessitates careful management to prevent inadvertent information disclosure.

Furthermore, the foregoing problem(s) with maintaining integrations'compliance with an organization's policies and organization-owned content access policies may be exacerbated as a provider's platform suite grows. For example, a provider that maintains three separate platforms may choose to provide three separate integrations interconnecting all three platforms (e.g., 3 choose 2). In this example, the provider is also tasked with maintaining policy compliance associated with those three platforms and three integrations. If the provider on-boards yet another platform, a total of six integrations may be required (e.g., 4 choose 2). If the provider on-boards a fifth platform, a total of ten integrations may be required (e.g., 5 choose 2). Generally, difficulties of maintaining integrations between different software platforms (in a permissions policy compliant manner) scales exponentially with the number of platforms provided.

Further to the inadvertent disclosure risk and maintenance obligations associated with inter-platform integrations, each integration is still only configured for information sharing, and not automation of tasks. Although context switching to copy data between two integrated platforms may be reduced, the quantity of tasks required by individual users may not be substantially reduced.

Further solutions involve creating and deploying dedicated automation platforms that may be configured to operate with one, and/or perform automations of, or more platforms of a multiplatform system. These, however, much like automation engines in-built to individual platforms, may be difficult to use, access, or understand. Similarly, much like integrations described above, dedicated automation platforms require separate maintenance and employee training, in addition to licensing costs and physical or virtual infrastructure allocations to support the automation platform(s).

In still further other circumstances, many automations may take longer for a user to create than the time saved by automating that particular task. In these examples, individual users may avoid defining automations altogether, despite that, in aggregate, automation of a given task may save an organization substantial time and cost.

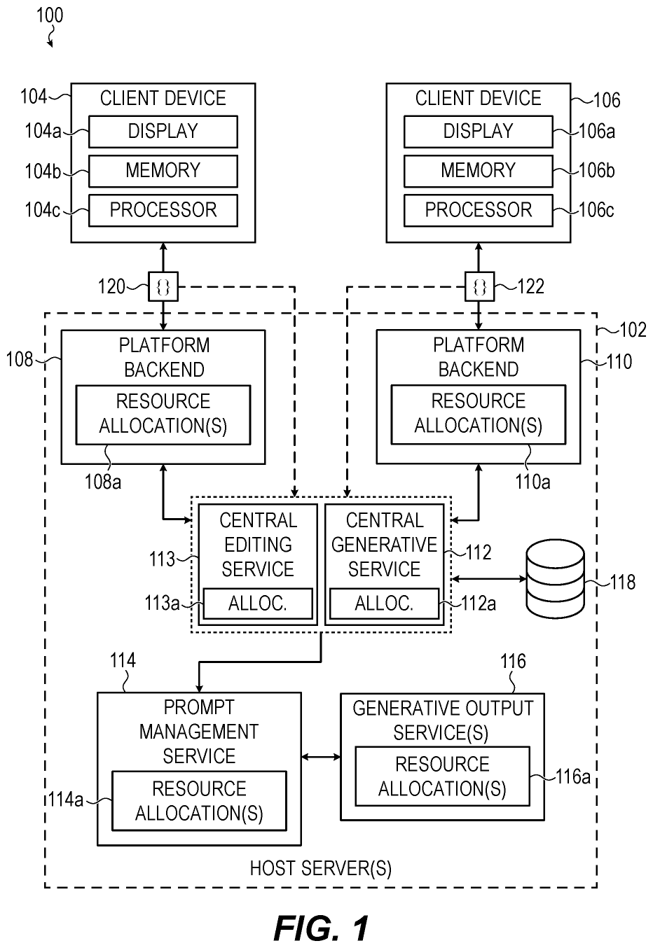

These foregoing and other embodiments are discussed below with reference to FIGS. 1-16. However, the detailed description given herein with respect to these figures is for explanation only and should not be construed as limiting.

### USER INPUT RESULTING IN GENERATIVE OUTPUT

FIG. 1 depicts a simplified diagram of a system, such as described herein that can provide generative services to a knowledge base service, such as described herein. The system 100 may be used to produce generative issue summaries, knowledge base documents, and other responsive content in response to requests from the knowledge base service, or from other sources such as a natural language input provided to an input interface. As described herein, the system 100 may also be leveraged by a variety of platforms, content editor services, and other aspects of a larger system in order to produce generative content.

The system 100 is depicted as implemented in a client-server architecture, but it may be appreciated that this is merely one example and that other communications architectures are possible. In particular, the system 100 includes a set of host servers 102 which may be one or more virtual or physical computing resources (collectively referred in many cases as a “cloud platform”). In some cases, the set of host servers 102 can be physically collocated or in other cases, each may be positioned in a geographically unique location.

The set of host servers 102 can be communicably coupled to one or more client devices; two example devices are shown as the client device 104 and the client device 106. The client devices 104, 106 can be implemented as any suitable electronic device. In many embodiments, the client devices 104, 106 are personal computing devices such as desktop computers, laptop computers, or mobile phones.

The set of host servers 102 can be supporting infrastructure for one or more backend applications, each of which may be associated with a particular software platform, such as a documentation platform or an issue tracking platform. Other examples include ITSM systems, chat platforms, messaging platforms, and the like. These backends can be communicably coupled to a generative output engine that can be leveraged to provide unique intelligent functionality to each respective backend. For example, the generative output engine can be configured to receive user prompts, such as described above, to modify, create, or otherwise perform operations against content stored by each respective software platform.

By centralizing access to the generative output engine in this manner, the generative output platform can also serve as an integration between multiple platforms. For example, one platform may be a documentation platform and the other platform may be an issue tracking system. In these examples, a user of the documentation platform may input a prompt requesting a summary of the status of a particular project documented in a particular page of the documentation platform. A comprehensive continuation/response to this summary request may pull data or information from the issue tracking system, as well.

A user of the client devices may trigger production of generative output in a number of suitable ways. One example is shown in FIG. 1. In particular, in this embodiment, each of the software platforms can share a common feature, such as a common generative service, which may be rendered in a frame of the frontend user interfaces of both platforms.

Turning to FIG. 1, a portion of the set of host servers 102 can be allocated as physical infrastructure supporting a first platform backend 108 and a different portion of the set of host servers 102 can be allocated as physical infrastructure supporting a second platform backend 110.

The two different platforms may be instantiated over physical resources provided by the set of host servers 102. Once instantiated, the first platform backend 108 and the second platform backend 110 can each communicably couple to a centralized generative service 112.

The centralized generative service 112 can be configured to cause rendering of a frame or panel within respective frontends of each of the first platform backend 108 and the second platform backend 110. In this manner, and as a result of this construction, each of the first platform and the second platform present a consistent user content searching, content generating, or content editing experiences for accessing generative services including the search, chat, automated assistant services, and other operations described herein. For example, in one embodiment, a user in a multiplatform environment may use and operate a documentation platform and an issue tracking platform. In this example, both the issue tracking platform and the documentation platform may be associated with a respective frontend and a respective backend. Each platform may be additionally communicably and/or operably coupled to a centralized generative service 112 that can be called by each respective frontend whenever it is required to present the user of that respective frontend with a generative interface that may facilitate a chat-based exchange with one or more automated assistant services.

The documentation platform's frontend may call upon the centralized generative service 112 to assist with content discovery and creation with respect to pages or documents managed by the documentation platform. Similarly, the issue tracking platform's frontend may call upon the centralized generative service 112 to perform content discovery, generation, and management of issues or tickets managed by the issue tracking platform. Additionally, a knowledge base service may call upon the centralized generative service 112 to perform issue summarization and knowledge base document generation using issues managed by the issue tracking platform.

The system 100 may also include a centralized content editing frame service 113, which can operate an editor or editing service for each of multiple platforms. More specifically, the centralized content editing frame service 113 may be a rich text editor with added functionality (e.g., slash command interpretation, in-line images and media, and so on). As a result of this centralized architecture, multiple platforms in a multiplatform environment can leverage the features of the same rich text editor. This provides a consistent experience to users while dramatically simplifying processes of adding features to the editor. The centralized content editing frame service 113 can parse text input provided by users of the documentation platform frontend and/or the issue tracking platform backend, monitoring for command and control keywords, phrases, trigger characters, and so on. In many cases, for example, the centralized content editing frame service 113 can implement a slash command service that can be used by a user of either platform frontend to issue commands to the backend of the other system.

For example, the user of the documentation platform frontend can input a slash command to the content editing frame, rendered in the documentation platform frontend supported by the centralized content editing frame service 113, in order to type a prompt including an instruction to create a new issue or a set of new issues in the issue tracking platform. Similarly, the user of the issue tracking platform can leverage slash command syntax, enabled by the centralized content editing frame service 113, to create a prompt that includes an instruction to edit, create, or delete a document stored by the documentation platform.

As described herein, a “content editing frame” references a user interface element that can be leveraged by a user to draft and/or modify rich content including, but not limited to: formatted text; image editing; data tabling and charting; file viewing; and so on. These examples are not exhaustive; content editing elements can include and/or may be implemented to include many features, which may vary from embodiment to embodiment. For simplicity of description the embodiments that follow reference a centralized content editing frame service 113 configured for rich text editing, but it may be appreciated that this is merely one example.

As a result of architectures described herein, developers of software platforms that would otherwise dedicate resources to developing, maintaining, and supporting content editing features can dedicate more resources to developing other platform-differentiating features, without needing to allocate resources to development of software components that are already implemented in other platforms.

In addition, as a result of the architectures described herein, services supporting the centralized content editing frame service 113 can be extended to include additional features and functionality—such as a slash command and control feature—which, in turn, can automatically be leveraged by any further platform that incorporates a content editing frame, and/or otherwise integrates with the centralized content editing frame service 113 itself. In this example, slash commands facilitated by the editor service can be used to receive prompt instructions from users of either frontend. These prompts can be provided as input to a prompt engineering/prompt preconditioning service (such as the prompt management service 114) that, in turn, provides a modified user prompt as input to a generative output service 116.

Similar functionality can also be provided by the centralized generative service 112. For example, as described herein the centralized generative service 112 may provide a chat-based interface in a panel or region of a frontend application. Through a series of natural language inputs, the system may provide content discovery, content modification, content generation, or content management operations. In some cases, the centralized generative service 112 utilizes a variety of software plugins and/or automated assistant services to provide the requested operations. The centralized generative service 112 may generate prompts, which, in this example, can be provided as input to a prompt engineering/prompt preconditioning service (such as the prompt management service 114) that, in turn, provides a modified user prompt as input to a generative output service 116.

The generative output service may be hosted over the host servers 102 or, in other cases, may be a software instance instantiated over separate hardware. In some cases, the generative engine service may be a third-party service that serves an API interface to which one or more of the host services and/or preconditioning service can communicably couple. The generative output engine can be configured as described above to provide any suitable output, in any suitable form or format. Examples include content to be added to user-generated content, API request bodies, replacing user-generated content, and so on.

The centralized content editing frame service 113 and/or the centralized generative service 112 can be configured to provide suggested prompts to a user as the user types. For example, as a user begins typing a slash command in a frontend of some platform that has integrated with a centralized content editing frame service 113 as described herein, the centralized content editing frame service 113 can monitor the user's typing to provide one or more suggestions of prompts, commands, or controls (herein, simply “preconfigured prompts”) that may be useful to the particular user providing the text input. Similarly, the centralized generative service 112 may monitor the user's typing and provide one or more suggestions of prompts, commands, or controls. The suggested preconfigured prompts may be retrieved from a database 118. In some cases, each of the preconfigured prompts can include fields that can be replaced with user-specific content, whether generated in respect of the user's input or generated in respect of the user's identity and session.

In some embodiments, the centralized content editing frame service 113 and/or the centralized generative service 112 can be configured to suggest one or more prompts that can be provided as input to a generative output engine as described herein to perform a useful task, such as summarizing content rendered within the centralized content editing frame service 113, reformatting content rendered within the centralized content editing frame service 113, inserting cross-links within the centralized content editing frame service 113, and so on.

The ordering of the suggestion list and/or the content of the suggestion list may vary from user to user, user role to user role, and embodiment to embodiment. For example, when interacting with a documentation system, a user having a role of “developer” may be presented with prompts associated with tasks related to an issue tracking system and/or a code repository system. Alternatively, when interacting with the same documentation system, a user having a role of “human resources professional” may be presented with prompts associated with manipulating or summarizing information presented in a directory system or a benefits system, instead of the issue tracking system or the code repository system. More generally, in some embodiments described herein, a centralized content editing frame service 113 and/or the centralized generative service 112 can be configured to suggest to a user one or more prompts that can cause a generative output engine to provide useful output and/or perform a useful task for the user. These suggestions/prompts can be based on the user's role, a user interaction history by the same user, user interaction history of the user's colleagues, or any other suitable filtering/selection criteria.

In addition to the foregoing, a centralized content editing frame service 113 and/or the centralized generative service 112, as described herein, can be configured to suggest discrete commands that can be performed by one or more platforms. As with preceding examples, the ordering of the suggestion list and/or the content of the suggestion list may vary from embodiment to embodiment and user to user. For example, the commands and/or command types presented to the user may vary based on that user's history, the user's role, and so on.

More generally and broadly, the embodiments described herein reference systems and methods for sharing user interface elements rendered by a centralized content editing frame service 113 and features thereof (such as a slash command processor), between different software platforms in an authenticated and secure manner. For simplicity of description, the embodiments that follow reference a configuration in which a centralized content editing frame service is configured to implement a slash command feature—including slash command suggestions—but it may be appreciated that this is merely one example and other configurations and constructions are possible. Similarly, the centralized generative service 112 may be configured to implement a variety of commands initiated using a command character (e.g., a slash, @, or other special symbol), can be used to invoke various assistant services, plugins, or other operations from the generative interface.

The first platform backend 108 can be configured to communicably couple to a first platform frontend instantiated by cooperation of a memory and a processor of the client device 104. Once instantiated, the first platform frontend can be configured to leverage a display of the client device 104 to render a graphical user interface so as to present information to a user of the client device 104 and so as to collect information from a user of the client device 104. Collectively, the processor, memory, and display of the client device 104 are identified in FIG. 1 as the client device resources 104a-104c, respectively.

As with many embodiments described herein, the first platform frontend can be configured to communicate with the first platform backend 108 and/or the centralized content editing frame service 113 and the centralized generative service 112. Information can be transacted by and between the frontend, the first platform backend 108 and the centralized content editing frame service 113 and the centralized generative service 112 in any suitable manner, form, or format. In many embodiments, as noted above, the client device 104 and in particular the first platform frontend can be configured to send an authentication token 120 along with each request transmitted to any of the first platform backend 108 or the centralized content editing frame service 113, the centralized generative service 112, the preconditioning service or the generative output engine.

Similarly, the second platform backend 110 can be configured to communicably couple to a second platform frontend instantiated by cooperation of a memory and a processor of the client device 106. Once instantiated, the second platform frontend can be configured to leverage a display of the client device 106 to render a graphical user interface so as to present information to a user of the client device 106 and so as to collect information from a user of the client device 106. Collectively, the processor, memory, and display of the client device 106 are identified in FIG. 1 as the client device resources 106a-106c, respectively.

As with many embodiments described herein, the second platform frontend can be configured to communicate with the second platform backend 110 and/or the centralized content editing frame service 113 and the centralized generative service 112. Information can be transacted by and between the frontend, the second platform backend 110 and the centralized content editing frame service 113 and the centralized generative service 112 in any suitable manner, form, or format. In many embodiments, as noted above, the client device 106 and in particular the second platform frontend can be configured to send an authentication token 122 along with each request transmitted to any of the second platform backend 110 or the centralized content editing frame service 113 and the centralized generative service 112.

As a result of these constructions, the centralized content editing frame service 113 and the centralized generative service 112 can provide uniform feature sets to users of either the client device 104 or the client device 106. For example, the centralized content editing frame service 113 can implement a slash command processor to receive prompt input and/or preconfigured prompt selection provided by a user of the client device 104 to the first platform and/or to receive input provided by a different user of the client device 106 to the second platform.

The centralized content editing frame service 113 and the centralized generative service 112 may ensure that common features are available to frontends of different platforms. One such class of features provided by the centralized content editing frame service 113 and the centralized generative service 112 invokes output of a generative output engine of a service such as the generative engine output service 116.

For example, as noted above, the generative output service 116 can be used to generate content, supplement content, and/or generate API requests or API request bodies that cause one or both of the first platform backend 108 or the second platform backend 110 to perform a task. In some cases, an API request generated at least in part by the generative output service 116 can be directed to another system not depicted in FIG. 1. For example, the API request can be directed to a third-party service (e.g., referencing a callback, as one example, to either backend platform) or an integration software instance. The integration may facilitate data exchange between the second platform backend 110 and the first platform backend 108 or may be configured for another purpose.

As with other embodiments described herein, the prompt management service 114 can be configured to receive user input (provided via a graphical user interface of the client device 104 or the client device 106) from the centralized content editing frame service 113 and the centralized generative service 112. The user input may include a prompt to be continued by the generative output service 116.

The prompt management service 114 can be configured to modify the user input, supplement the user input, select a prompt from a database (e.g., the database 118) based on the user input, insert the user input into a template prompt, replace words within the user input, perform searches of databases (such as user graphs, team graphs, and so on) of either the first platform backend 108 or the second platform backend 110, change grammar or spelling of the user input, change a language of the user input, and so on. The prompt management service 114 may also be referred to herein as an “editor assistant service” or a “prompt constructor.” In some cases, the prompt management service 114 is also referred to as a “content creation and modification service.”

Output of the prompt management service 114 can be referred to as a modified prompt or a preconditioned prompt. This modified prompt can be provided to the generative output service 116 as an input. More particularly, the prompt management service 114 is configured to structure an API request to the generative output service 116. The API request can include the modified prompt as an attribute of a structured data object that serves as a body of the API request. Other attributes of the body of the API request can include, but are not limited to: an identifier of a particular LLM or generative engine to receive and continue the modified prompt; a user authentication token; a tenant authentication token; an API authorization token; a priority level at which the generative output service 116 should process the request; an output format or encryption identifier; and so on. One example of such an API request is a POST request to a Restful API endpoint served by the generative output service 116. In other cases, the prompt management service 114 may transmit data and/or communicate data to the generative output service 116 in another manner (e.g., referencing a text file at a shared file location, the text file including a prompt, referencing a prompt identifier, referencing a callback that can serve a prompt to the generative output service 116, initiating a stream comprising a prompt, referencing an index in a queue including multiple prompts, and so on; many configurations are possible).

In response to receiving a modified prompt as input, the generative output service 116 can execute an instance of a generative output engine, such as an LLM. As noted above, in some cases, the prompt management service 114 can be configured to specify what engine, engine version, language, language model or other data should be used to continue a particular modified prompt.

The selected LLM or other generative engine continues the input prompt and returns that continuation to the caller, which in many cases may be the prompt management service 114. In other cases, output of the generative output service 116 can be provided to the centralized content editing frame service 113 or the centralized generative service 112 to return to a suitable backend application, to in turn return to or perform a task for the benefit of a client device such as the client device 104 or the client device 106. More particularly, it may be appreciated that although FIG. 1 is illustrated with only the prompt management service 114 communicably coupled to the generative output service 116, this is merely one example and, in other cases, the generative output service 116 can be communicably coupled to any of the client device 106, the client device 104, the first platform backend 108, the second platform backend 110, the centralized content editing frame service 113, the centralized generative service 112, or the prompt management service 114.

In some cases, output of the generative output service 116 can be provided to an output processor or gateway configured to route the response to an appropriate destination. For example, in an embodiment, output of the generative engine may be intended to be prepended to an existing document of a documentation system. In this example, it may be appropriate for the output processor to direct the output of the generative output service 116 to the frontend (e.g., rendered on the client device 104, as one example) so that a user of the client device 104 can approve the content before it is prepended to the document. In another example, output of the generative output service 116 can be inserted into an API request directly to a backend associated with the documentation system. The API request can cause the backend of the documentation system to update an internal object representing the document to be updated. On an update of the document by the backend, a frontend may be updated so that a user of the client device can review and consume the updated content.

In other cases, the output processor/gateway can be configured to determine whether an output of the generative output service 116 is an API request that should be directed to a particular endpoint. Upon identifying an intended or specified endpoint, the output processor can transmit the output, as an API request to that endpoint. The gateway may receive a response to the API request which in some examples, may be directed to yet another system (e.g., a notification that an object has been modified successfully in one system may be transmitted to another system).

More generally, the embodiments described herein and with particular reference to FIG. 1 relate to systems for collecting user input, modifying that user input into a particularly engineered prompt, and submitting that prompt as input to a trained large language model. Output of the LLM can be used in a number of suitable ways.

In some embodiments, user input can be provided by text input that can be provided by a user typing a word or phrase into an editable dialog box such as a rich text editing frame rendered within a user interface of a frontend application on a display of a client device. For example, the user can type a particular character or phrase in order to instruct the frontend to enter a command receptive mode. In some cases, the frontend may render an overlay user interface that provides a visual indication that the frontend is ready to receive a command from the user. As the user continues to type, one or more suggestions may be shown in a modal UI window.

These suggestions can include and/or may be associated with one or more “preconfigured prompts” that are engineered to cause an LLM to provide particular output. More specifically, a preconfigured prompt may be a static string of characters, symbols and words, that causes—deterministically or pseudo-deterministically—the LLM to provide consistent output. For example, a preconfigured prompt may be “generate a summary of changes made to all documents in the last two weeks.” Preconfigured prompts can be associated with an identifier or a title shown to the user, such as “Summarize Recent System Changes.” In this example, a button with the title “Summarize Recent System Changes” can be rendered for a user in a UI as described herein. Upon interaction with the button by the user, the prompt string “generate a summary of changes made to all documents in the last two weeks” can be retrieved from a database or other memory, and provided as input to the generative output service 116.

Suggestions rendered in a UI can also include and/or may be associated with one or more configurable or “templatized prompts” that are engineered with one or more fields that can be populated with data or information before being provided as input to an LLM. An example of a templatized prompt may be “summarize all tasks assigned to ${user} with a due date in the next 2 days.” In this example, the token/field/variable ${user} can be replaced with a user identifier corresponding to the user currently operating a client device.

This insertion of an unambiguous user identifier can be performed by the client device, the platform backend, the centralized content editing frame service, the prompt management service, or any other suitable software instance. As with preconfigured prompts, templatized prompts can be associated with an identifier or a title shown to the user, such as “Show My Tasks Due Soon.” In this example, a button with the title “Show My Tasks Due Soon” can be rendered for a user in a UI as described herein. Upon interaction with the button by the user, the prompt string “summarize all tasks assigned to user123 with a due date in the next 2 days” can be retrieved from a database or other memory, and provided as input to the generative output service 116.

Suggestions rendered in UI can also include and/or may be associated with one or more “engineered template prompts” that are configured to add context to a given user input. The context may be an instruction describing how particular output of the LLM/engine should be formatted, how a particular data item can be retrieved by the engine, or the like. As one example, an engineered template prompt may be “${user prompt}. Provide output of any table in the form of a tab delimited table formatted according to the markdown specification.” In this example, the variable ${user prompt} may be replaced with the user prompt such that the entire prompt received by the generative output service 116 can include the user prompt and the example sentence describing how a table should be formatted.

In yet other embodiments, a suggestion may be generated by the generative output service 116. For example, in some embodiments, a system as described herein can be configured to assist a user in overcoming a cold start/blank page problem when interacting with a new document, new issue, or new board for the first time. For example, an example backend system may be Kanban board system for organizing work associated with particular milestones of a particular project. In these examples, a user needing to create a new board from scratch (e.g., for a new project) may be unsure how to begin, causing delay, confusion, and frustration.

In these examples, a system as described herein can be configured to automatically suggest one or more prompts configured to obtain output from an LLM that programmatically creates a template board with a set of template cards. Specifically, the prompt may be a preconfigured prompt as described above such as “generate a JSON document representation of a Kanban board with a set of cards each representing a different suggested task in a project for creating a new iced cream flavor.” In response to this prompt, the generative output service 116 may generate a set of JSON objects that, when received by the Kanban platform, are rendered as a set of cards in a Kanban board, each card including a different title and description corresponding to different tasks that may be associated with steps for creating a new iced cream flavor. In this manner, the user can quickly be presented with an example set of initial tasks for a new project.

In yet other examples, suggestions can be configured to select or modify prompts that cause the generative output service 116 to interact with multiple systems. For example, a suggestion in a documentation system may be to create a new document content section that summarizes a history of agent interactions in an ITSM system. In some cases, the generative output service 116 can be called more than once and/or it may be configured to generate its own follow-up prompts or prompt templates which can be populated with appropriate information and re-submitted to the generative output service 116 to obtain further generative output. More simply, in some embodiments, generative output may be recursive, iterative, or otherwise multi-step.

These foregoing embodiments depicted in FIG. 1 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. Many modifications and variations are possible in view of the above teachings.

For example, it may be appreciated that all software instances described above are supported by and instantiated over physical hardware and/or allocations of processing/memory capacity of physical processing and memory hardware. For example, the first platform backend 108 may be instantiated by cooperation of a processor and memory collectively represented in the figure as the resource allocations 108a. Similarly, the second platform backend 110 may be instantiated over the resource allocations 110a (including processors, memory, storage, network communications systems, and so on). The centralized content editing frame service 113 is supported by a processor and memory and network connection (and/or database connections) collectively represented for simplicity as the resource allocations 113a. The centralized generative service 112 is supported by a processor and memory and network connection (and/or database connections) collectively represented for simplicity as the resource allocations 112a. The prompt management service 114 can be supported by its own resources including processors, memory, network connections, displays (optionally), and the like represented in the figure as the resource allocations 114a.

In many cases, the generative output service 116 may be an external system, instantiated over external and/or third-party hardware which may include processors, network connections, memory, databases, and the like. In some embodiments, the generative output service 116 may be instantiated over physical hardware associated with the host servers 102. Regardless of the physical location at which (and/or the physical hardware over which) the generative output service 116 is instantiated, the underlying physical hardware including processors, memory, storage, network connections, and the like are represented in the figure as the resource allocations 116a.

Further, although many examples are provided above, it may be appreciated that in many embodiments, user permissions and authentication operations are performed at each communication between different systems described above. Phrased in another manner, each request/response transmitted as described above or elsewhere herein may be accompanied by user authentication tokens, user session tokens, API tokens, or other authentication or authorization credentials.

Generative output systems, as described herein, should not be usable to obtain information from an organizations datasets that a user is otherwise not permitted to obtain. For example, a prompt “generate a table of social security numbers of all employees” should not be executable. In many cases, underlying training data may be siloed based on user roles or authentication profiles. In other cases, underlying training data can be preconditioned/scrubbed/tagged for particularly sensitive datatypes, such as personally identifying information. As a result of tagging, prompts may be engineered to prevent any tagged data from being returned in response to any request. More particularly, in some configurations, all prompts output from the prompt management service 114 may include a phrase directing an LLM to never return particular data, or to only return data from particular sources, and the like.

In some embodiments, the system 100 can include a prompt context analysis instance configured to determine whether a user issuing a request has permission to access the resources required to service that request. For example, a prompt from a user may be “Generate a text summary in Document123 of all changes to Kanban board 456 that do not have a corresponding issue tagged in the issue tracking system.” In respect of this example, the prompt context analysis instance may determine whether the requesting user has permission to access Document123, whether the requesting user has written permission to modify Document123, whether the requesting user has read access to Kanban board 456, and whether the requesting user has read access to referenced issue tracking system. In some embodiments, the request may be modified to accommodate a user's limited permissions. In other cases, the request may be rejected outright before providing any input to the generative output service 116.

Furthermore, the system can include a prompt context analysis instance or other service that monitors user input and/or generative output for compliance with a set of policies or content guidelines associated with the tenant or organization. For instance, the service may monitor the content of a user input and block potential ethical violations including hate speech, derogatory language, or other content that may violate a set of policies or content guidelines. The service may also monitor output of the generative engine to ensure the generative content or response is also in compliance with policies or guidelines. To perform these monitoring activities, the system may perform natural language processing on the monitored content in order to detect keywords or phrases that indicate potential content violations. A trained model may also be used that has been trained using content known to be in violation of the content guidelines or policies.

Further to these foregoing embodiments, it may be appreciated that a user can provide input to a frontend of a system in a number of suitable ways, including by providing input as described above to a frame rendered with support of a centralized content editing frame service 113 or a centralized generative service 112.

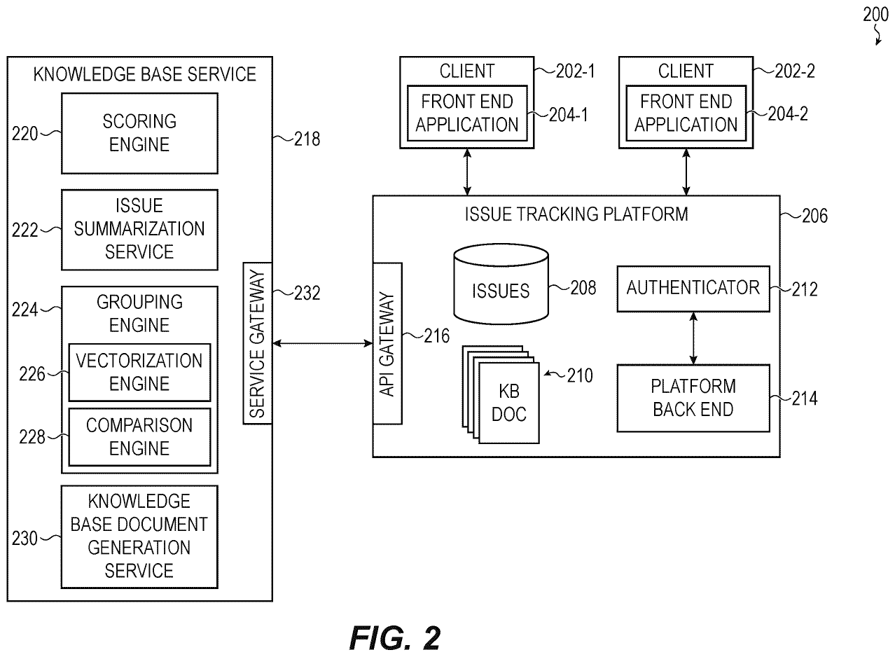

FIG. 2 depicts an example system 200 in which a knowledge base document service 218 (also referred to simply as knowledge base service 218) may interact with an issue tracking platform 206 to identify subject areas for which additional knowledge base documents may be warranted. As a particular example, and as described herein, the knowledge base service 218 may determine what product components (or support topics) supported by the issue tracking platform 206 are deficient in knowledge base documents or could otherwise benefit from having additional knowledge base documents.

The system 200 includes clients 202 (202-1, 202-2). The clients can be implemented as any suitable electronic device. In many embodiments, the client devices 202 are personal computing devices such as desktop computers, laptop computers, or mobile phones. The clients 202 execute respective frontend applications 204 (204-1, 204-2). The frontend applications 204 may be frontend applications of the issue tracking platform 206. For example, the frontend applications may instantiate graphical user interfaces with which support agents or other individuals may interact with the issue tracking platform 206 and access the functions of the issue tracking platform 206. For example, the frontend applications may facilitate functions such as generating issues, communicating with users regarding issues and/or support topics (e.g., via chat, messaging services, email, voice, video, etc.), updating issues, advancing issues through issue workflows, accessing knowledge base documents of the issue tracking platform 206, generating knowledge base documents, and the like.

The issue tracking platform 206 includes a platform backend 214 that generally provides the functions of the issue tracking platform 206. For example, the platform backend 214 may provide services related to the generation, storage, and management of issues in the issue tracking platform 206. The platform backend 214 may interface with the frontend applications 204 to provide issue tracking functionality to the client devices 202.

An authentication service 212 may be configured to authenticate users with respect to a user account with the issue tracking platform 206. The authentication service 212 may receive credentials from a user (e.g., username and password, biometric information, or the like). The authentication service 212 may locate the credentials in a user data store and perform an authentication operation (e.g., comparing a hashed password input to a stored password hash). If the authentication operation is successful, the user may be authenticated with respect to the issue tracking platform 206. When a user is authenticated by the authentication service 212, an authenticated session may be created for the user. The authenticated session may allow the user to access certain functionalities and services of the issue tracking platform 206, such as functionalities and services that are restricted to authenticated users.

The issue tracking platform 206 also includes or accesses an issue data store 208 and a knowledge base document data store 210. The issue data store 208 may store issues that are hosted by the issue tracking platform 206. Issues may include information about support topics that are relevant to the services and/or products supported by the issue tracking platform 206. For example, issues may include an issue identifier, a description of the support topic, records of communications between users and agents, information about how the issue was resolved, links to resources used in the resolution of the issue, issue metadata, as well as other information. At least some of the issue information may be generated by an agent who is handling the issue. The issues in the issue data store 208 may be stored in any suitable manner, including as one or more files, an issue definition that references distributed information, or the like.

The knowledge base document data store 210 stores knowledge base documents associated with the issue tracking platform 206. The knowledge base documents may be generated by agents, administrators, or other uses of the issue tracking platform 206, and may include information that aids in the resolution of issues or support topics that are serviced by the issue tracking platform 206. For example, knowledge base documents may include descriptions of known support topics, as well as workflows, procedures, references, or other information that can be used to resolve those support topics. Agents of the issue tracking platform 206 may search for and access the knowledge base documents when assisting users with support topics. As described herein, knowledge base documents may also be automatically generated by a knowledge base service 218 and stored in the knowledge base document data store 210 for access and reference by agents. In some cases, as described herein, issues may include links or other references to existing knowledge base documents in the knowledge base document data store 210. A link, in an issue, to a knowledge base document indicates that the content of that particular knowledge base document is relevant to the support topic of the issue. This link (or any other association between knowledge base documents and issues) may be used by the knowledge base service 218 for various purposes, such as to determine resource priority scores for different product components and/or support topics, and/or to generate issue summaries and knowledge base documents. For example, when generating an issue summary for an issue, a generative service may be provided with information from a knowledge base document that is referred to in the issue. The generative service may incorporate or otherwise use the information from the knowledge base document when generating the issue summary.

The issue tracking platform 206 may also include an API gateway 216, which may facilitate interactions and/or communications with other services, such as the knowledge base service 218.

The knowledge base service 218 may include a service gateway 232 for communicating with other services and/or platforms, such as the issue tracking platform 206. For example, the knowledge base service 218 may issue requests to the API gateway 216 to access information in the issue tracking platform 206, such as issues in the issue data store 208, knowledge base documents in the knowledge base document data store 210, and the like. While the communication between the knowledge base service 218 and the issue tracking platform 206 is primarily described with respect to the knowledge base service 218 initiating requests to the issue tracking platform 206, this is merely exemplary, and any communications may be supported by the gateways, including requests initiated by the issue tracking platform 206 and sent to the knowledge base service 218, or communications between these and other systems (e.g., the generative service 112 of FIG. 1). In some cases, the service gateway 232 and the API gateway 216 may validate incoming requests and verify, by querying a permissions table, directory service, or other authentication system whether a particular request is authorized.

The knowledge base service 218 interfaces with the issue tracking platform 206 and/or other components or services to identify product components and/or support topics for which to generate knowledge base documents, and automatically generate such documents for retrieval and use by users of the issue tracking platform 206.

The knowledge base service 218 may include a scoring engine 220, an issue summarization service 222, a grouping engine 224, and a knowledge base document generation service 230, along with the service gateway 232. As noted, the service gateway 232 may facilitate communications between the knowledge base document service 218 (and its components) and the issue tracking platform 206 as well as other platforms, services, and the like. For example, in some cases, the service gateway 232 facilitates communications between the components of the knowledge base service 218 and one or more generative services (e.g., the generative service 112 of FIG. 1).

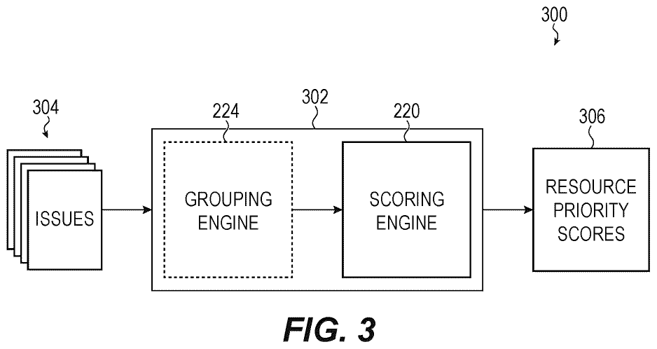

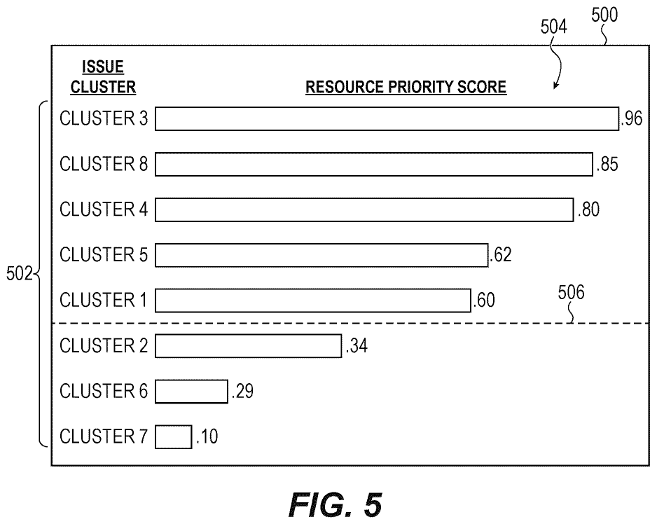

The scoring engine 220 may be configured to generate resource priority scores for product components and/or support topics that are associated with the issues in the issue tracking platform 206. For example, issue clusters may be defined from a body of issues 208 hosted by the issue tracking platform 206. Each issue cluster may be associated with a product component, such as a component or feature of a software product (though it will be appreciated that a product component is not limited to a software product, and may generally refer to any subject to which an issue may refer). The scoring engine 220 may determine resource priority scores for the product components referred to in those issue clusters. Further explanation and examples of the scoring engine and the resource priority scores are provided herein (e.g., with respect to FIGS. 3, 5).

Once resource priority scores are determined, one or more issue clusters may be selected to form the basis of new knowledge base documents. The issue summarization service 222 is configured to generate issue summaries of the selected issue clusters. For example, the issue summarization service 222 may access the issues of the identified cluster, and use a generative service to produce issue summaries. The issue summaries may represent a more condensed, focused summary of the underling issues, and may provide a basis from which knowledge base documents may be generated. For example, issues may include myriad information that should not be included in a knowledge base document, such as issue identification numbers, timestamps, metadata, and other information that is useful in the tracking of issues, but is not relevant to the resolution of the underlying support topic. Accordingly, the issue summarization service 222 may be configured to produce summaries that are based on the information in the underlying issue, and that focus on the most salient information related to the description and resolution of the underlying support topic.

The grouping engine 224 may be configured to identify groups of issues or issue summaries that relate to similar product component, support topics, or the like. In some cases, the grouping engine 224 may be used to determine similarity between issues and/or issue summaries based on various levels of abstraction or granularity, depending on the particular application. As one example, as described herein, the grouping engine 224 may be used to determine clusters of issues that relate to a same product component. As another example, the grouping engine 224 may be used to determine groups of issue summaries (or issues) that relate to a same support topic. More particularly, product components may be associated with multiple different support topics, such as when users have different questions or problems relating to a same product component, and at different stages or operations of the techniques described herein, different types of similarities may be used. Thus, the grouping engine 224 may determine different granularities or specificities of similarity depending on the particular use case, as described in greater detail herein.

The grouping engine 224 may determine semantic similarities between content items (e.g., issues, issue summaries, etc.) in various ways. For example, the grouping engine 224 may include a vectorization engine 226 that produces vectors based on the content to be evaluated, and a comparison engine 228 that compares the vectors of the underlying content items to determine a semantic similarity of the content items and identifies issue clusters based on the similarity. In some cases, the comparison engine 228 may use cosine similarity to determine the similarity between the content items. Other techniques for determining similarities between content items (and thus identifying groupings of similar content items) include, without limitation, dot product similarity, Euclidean distance, deep learning-based models (e.g., sentence transformers), and the like. In some cases, the grouping engine 224 may determine whether content items satisfy semantic similarity conditions. For example, a semantic similarity condition may correspond to a threshold distance or difference between the vectors of a content item. Thus, for example, content items may be determined to be semantically similar (and thus may be grouped or clustered together) if the difference between the vectors is below a threshold distance.

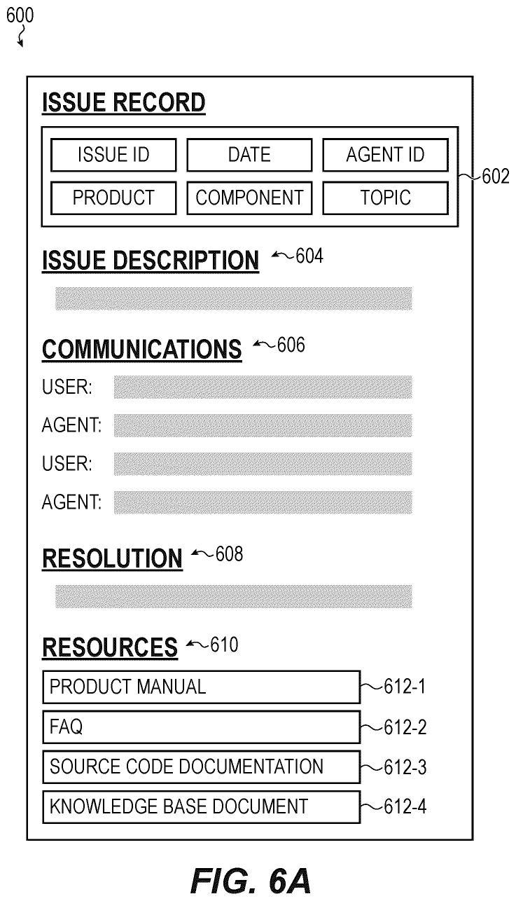

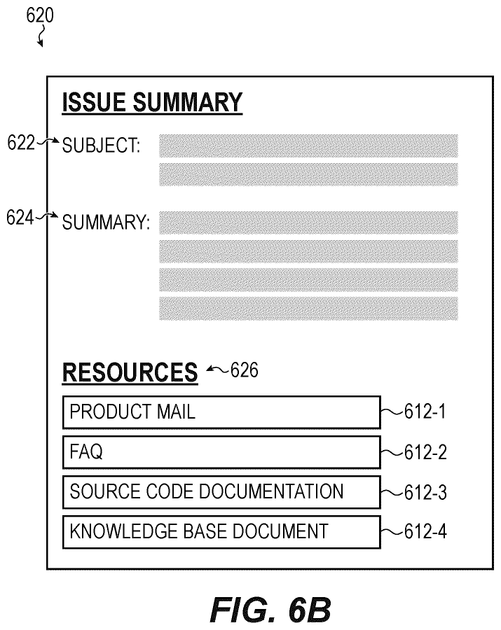

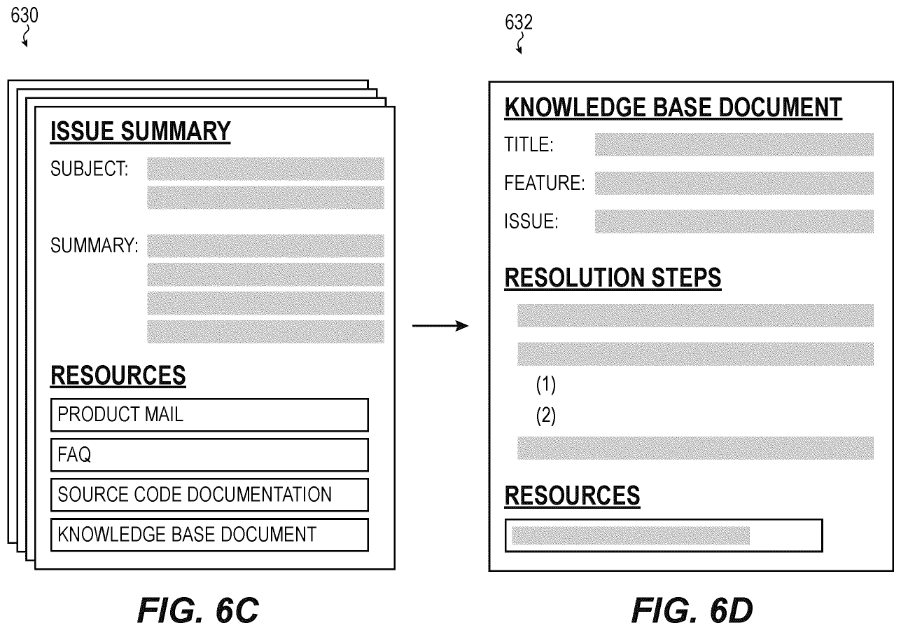

The knowledge base service 218 also includes a knowledge base document generation service 230. The knowledge base document generation service 230 may generate knowledge base documents for product components and/or support topics with resource priority scores that satisfy evaluation criteria. As described in greater detail herein, the knowledge base document generation service 230 may use a generative service (e.g., the generative service 112, FIG. 1) to generate the knowledge base documents. For example, the knowledge base document generation service 230 may generate knowledge base document generation prompts for submission to a generative service. The knowledge base document generation prompts may include predetermined query prompt text, as well as text content extracted from at least a subset of the issue summaries on which the knowledge base document is to be based. Optionally, the prompts may include text extracted from other sources as well, such as other knowledge base documents or other resources (e.g., knowledge base documents, webpages, manuals, product specifications and documentation, source code, source code comments, etc.) that are linked or otherwise identified in the issues or issue summaries (e.g., resources 610, FIG. 6A). Including text from the issue summaries and/or associated resources results in the knowledge base document generation prompts results in knowledge base documents that are highly relevant to the issues and support topics for which additional knowledge base documents are needed.

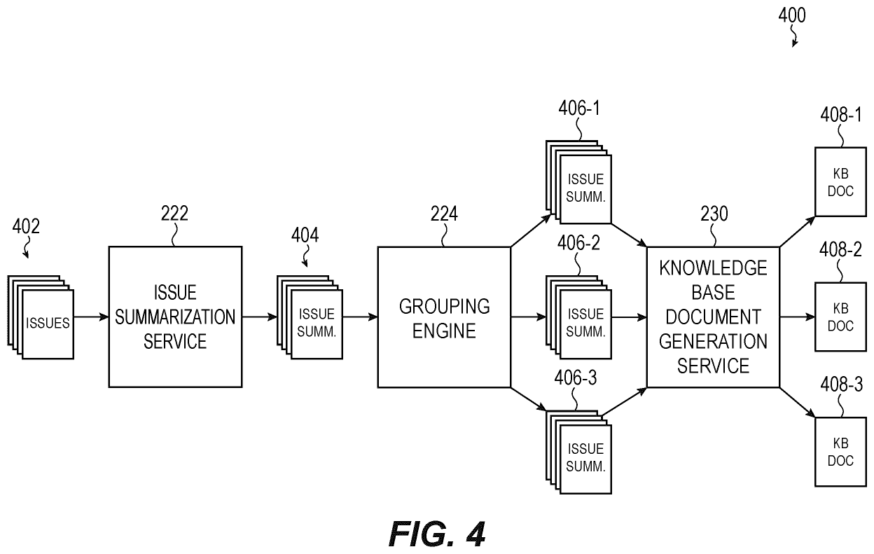

FIGS. 3 and 4 illustrate example processes by which the knowledge base service 218 may automatically identify particular product components and/or support topics for which to generate knowledge base documents, and automatically generate such documents. FIG. 3 illustrates an example resource priority scoring operation 300. The operation 300 may be performed by the knowledge base service 218. The operation 300 may utilize a scoring pipeline 302 that includes the scoring engine 220, and optionally the grouping engine 224.

As described herein, a set of issues 304 may be identified for analysis. In some cases, the issues 304 may be organized into issue clusters, with each cluster related to a respective product component. Issue clusters may be defined in various ways. For example, issues in an issue tracking platform may be tagged (e.g., by an agent or automatically by a tagging engine), with information indicating one or more subjects or concepts to which the issue relates. For example, an issue may be tagged with a name of a software product or a name of a product component to which the issue relates. Issues may be tagged or otherwise organized to various degrees of specificity, and issue clusters may therefore be similarly scaled. Thus, issues may be defined by reference to tags that are assigned to or associated with the issues.

In some cases, such as where issue clusters have not been defined for the issues 304, the issues may be clustered by the grouping engine 224. For example, the grouping engine 224 may determine clusters of issues based on a semantic similarity of the issues (e.g., using a vectorization engine 226 and a comparison engine 228, as described herein). In such cases, the grouping engine 224 may define clusters of issues that satisfy a similarity threshold or are otherwise likely to relate to a same product component.

Once the issue clusters for the issues 304 are defined, the scoring engine 220 analyzes the issue clusters and determines resource priority scores 306 for each issue cluster. Since issue clusters may be defined to generally correspond to product components, the resource priority scores may be understood to rank a particular product component. In some cases, issue clusters may be defined differently, such as to correspond to a particular support topic (where multiple support topics may be associated with a single product component). As described herein, the resource priority score is indicative of an extent to which a particular product component or support topic needs additional knowledge base documents. More generally, the resource priority scores allow the knowledge base system 218 to identify issues where agents have been resolving or assisting with issues for which no or too few relevant knowledge base documents exist. In this way, the knowledge base service may select the highest-value software products or support topics for which to generate new knowledge base documents.

The scoring engine 220 may determine the resource priority scores 306 according to various metrics. In some cases, the resource priority scores for an issue cluster (and thus a product component) are based on factors including, but not limited to, on an amount of issues in the issue cluster, an amount of knowledge base documents available in relation to the product component, a relative amount of issues relating to that product component as compared to an overall amount of issues, an amount of time spent by operators working on issues in the issue cluster, a ranking of the knowledge base documents that are associated with the software component and/or issues in the issue cluster (e.g., based on user-generated feedback or votes associated with knowledge base documents), an amount of issues that are marked as resolved (e.g., associated with a workflow state of “resolved” or “completed” that do not have an associated knowledge base document), and the like. These (or other) factors may be weighted relative to one another to determine scores that accurately indicate which product components have the highest need or priority for additional knowledge base documents.

In some cases, an important indicator of a need for knowledge base documents may be that issues are being resolved without reference to any knowledge base document, or without a specific reference to a knowledge base document as a “resolving” document. More particularly, issues may include links to or other identifiers of various resources that were used by an agent during the resolution of an issue. In some cases, certain resources may be separately identified as a “resolving” document, indicating that the resource contained a solution to the issue (and/or information from which the issue can be resolved). If there are many issues relating to the same product component or support topic that do not have associated knowledge base documents and/or do not have an associated “resolving” knowledge base document, that may be a good indication that additional knowledge base documents would be helpful for that particular product component or support topic. Accordingly, the resource priority scores determined by the scoring engine 220 may be based at least in part on an amount of issues that are resolved without reference to a knowledge base document that can be considered a “resolving” document or resource.

The scoring engine 220 (or the knowledge base service 218 more generally) may select, based on the resource priority scores of the analyzed issue clusters, which product components or support topics the knowledge base service 218 will generate knowledge base documents for. For example, the scoring engine 220 (or the knowledge base service 218) may determine which resources priority scores satisfy an evaluation condition. The evaluation condition may correspond to a threshold resource priority score, and/or may be based on a ranking of resource priority scores of various issue clusters. FIG. 5 illustrates example resource priority scores of various issue clusters of a body of issues. The knowledge base service 218 may continue knowledge base document generation operations for the issue clusters that satisfy the evaluation condition. FIG. 4, described herein, illustrates an example knowledge base document generation operation 400 that may be implemented for a cluster of issues whose resource priority score satisfies the evaluation condition. It will be understood that the knowledge base service 218 may repeat this operation for each issue cluster (or product component or support topic) with resource priority scores that satisfy the evaluation condition. In some cases, the resource priority scoring operation 300 is repeated periodically or regularly for a body of issues to obtain updated scores for the ever-changing body of issues, and the knowledge base document generation operations are also repeated, based on the updated scores, to continue to generate the needed knowledge base documents.

With reference to FIG. 4, an issue cluster 402 may be selected, as described above, based on the resource priority score for that cluster satisfying an evaluation condition. The issues 402 may be accessed by the issue summarization service 222, which generates a set of issue summaries from the set of issues 402. Generating issue summaries for the issues may include generating an issue summarization prompt for each issue, where the issue summarization prompt includes predetermined query prompt text, and text content extracted from the particular issue.

The issue summarization prompt may be provided to a generative service (e.g., the generative service 112, FIG. 1), which may return the issue summaries to the knowledge base service 218 for further processing. The predetermined query prompt text may be configured to cause the generative service to produce issue summaries that include appropriate content and have a consistent and expected output format. For example, the query prompt text may include a specification of the particular fields that the issue summary should include, and what type of content should be included in each field. In this way, the issue summaries may be configured for further processing by the knowledge base service 218. The text content extracted from the issue may be included in the issue summarization prompt so that the generative service can produce a useful and representative summary of the most salient portions of the issue. For example, the text extracted from the issue (which is included in the prompt) may include a communication record extracted from an issue. For example, issues may include a record of communications between an agent (or other operator of the issue tracking system) and a user. The communications may include instant messages, emails, chat logs, or the like, and may include substantive discussions of the support topic, troubleshooting steps, and how the issue was ultimately resolved. Accordingly, the communications may provide substantive content that is relevant to the issue and/or product component and that the generative service may use when generating an issue summary.

As described above, issues may also include links to or identifiers of resource documents that an agent consulted or otherwise includes information that is relevant to the issue. Such resource documents may include content that is relevant to the issue and/or product component, and/or the resolution of the issue. Accordingly, the issue summarization prompt may include text extracted from the resource documents, such that the issue summary may be based at least in part on the extracted text. Example resource documents may include knowledge base documents, webpages, manuals, product specifications and documentation, source code, source code comments, and the like. In some cases, the issue summarization service also associates all or a subset of the identifiers of the resource documents from an underlying issue into the issue summary for that issue.

Once the issue summarization prompt is generated, the issue summarization prompt is provided to the generative output service, and a generative response is received from the generative output service. The issue summarization service 222 may use the generative response to generate an issue summary 404 for each issue summarization prompt (e.g., for each issue in the identified issue cluster 402). In some cases, the issue summarization service 222 may incorporate the generative response (or a portion thereof) into an issue summary that also includes other information, such as links to or identifiers of resource documents, issue metadata, links to or identifiers of the underlying issue, and the like. In some cases, the generative response is a complete issue summary, and the issue summarization service simply outputs the generative response as the issue summaries 404.

In some cases, issue summaries 404 are provided as input to a grouping engine 224. The grouping engine 224 may be configured to select a group of issue summaries, from the issue summaries 404, based on a semantic similarity of the issue summaries. This operation may help identify issues in the issue cluster 402 that relate to a same support topic and/or a same resolution to the support topic. More particularly, issue clusters may be clustered based on product components, and each product component may have multiple associated support topics. Accordingly, the grouping engine 224 may identify groups of issue summaries 406 that satisfy a semantic similarity condition indicating that they are semantically similar and are likely associated with a same support topic. By grouping the issue summaries based on semantic similarity, the knowledge base document that is ultimately generated from that group of summaries may be narrowly focused on a specific support topic, which may ultimately improve the quality and usefulness of the knowledge base document. Furthermore, by identifying issue summaries that are semantically similar, the grouping engine 224 may ultimately identify issues that had the same or similar resolution to the support topic. In this way, the knowledge base document that is ultimately generated from the issue summaries may be focused on a single technique for resolving the support topic. In some cases, however, the grouping engine 224 may include issues with different resolutions, which may facilitate the generation of knowledge base documents that include multiple possible or alternative resolutions to a same support topic. In such cases, the grouping engine 224 may be configured to group issue summaries based on the similarity of the underlying issue, and not the resolution.

In some cases, issue summaries may be configured to include separate fields for a description of the underlying support topic, and for a description of the resolution. This structure may facilitate various implementations of the grouping engine 224, as described above (e.g., allowing the grouping engine 224 to identify similarity of issue records based on the similarity of the support topics, the resolutions, both the support topics and resolutions, and/or other factors).

As described herein, the grouping engine 224 may include a vectorization engine 226 that produces content vectors based on some or all of the content of the issue summaries, and a comparison engine 228 that compares the vectors of the issue summaries to determine a semantic similarity of the issue summaries (or a portion thereof). In some cases, the comparison engine 228 may use cosine similarity to determine the similarity between the issue summaries. Other techniques for determining similarities between issue summaries (and thus identifying groupings of similar issue summaries) include, without limitation, dot product similarity, Euclidean distance, deep learning-based models (e.g., sentence transformers), and the like.

Ultimately, a group of issue summaries is selected to be used as the basis for a knowledge base document. The selection may be based on various factors. For example, in some cases, the selection is based on a determination that none of the issue summaries in the group of issue summaries are associated with any knowledge base document in the issue tracking platform. More particularly, if none of the issue summaries in a group of issue summaries are associated with a knowledge base document, that is a good indication that generating a knowledge base document for that support topic or product component will be beneficial for the issue tracking platform and its agents or operators. As described herein, issues may identify one or more knowledge base documents as “resolving” documents or resources. In some cases, the group of issue summaries that is selected corresponds to a group of issue summaries where none of the underlying issues are associated with a resolving document or resource (or where the proportion of issues that include a resolving document is below a threshold condition). In some cases, the knowledge base service 218 may determine whether an issue summary is associated with a resolving document based on information in the issue summary (e.g., the issue summary may indicate whether the underlying issue is associated with a resolving document), or by analyzing the issue on which an issue summary is based.

Once a group of issue summaries is selected to be used as the basis for a knowledge base document, the knowledge base document generation service 230 may access or otherwise use the group of issue summaries to generate a knowledge base document. More particularly, the knowledge base document generation service 230 may generate a knowledge base document generation prompt that includes predetermined query prompt text, and text content extracted from at least a subset of the selected group of issue summaries. The predetermined query prompt text may be configured to cause the generative service to produce knowledge base documents that have appropriate content and have a consistent and expected output format. For example, the query prompt text may include a specification of the particular fields that the knowledge base document should include, and what type of content should be included in each field.

The knowledge base document generation query may also include various substantive text content that the generative service may use to generate the knowledge base document. The text content may include text content extracted from the issue summaries in the selected group of issue summaries, which may provide substantive summaries of the support topic, the product component, the resolution steps, and the like. The knowledge base document query may also include text content extracted from the underlying issue from which an issue summary was generated, including, for example, a communication record extracted from the issue, a user-generated description of the support topic, a user-generated description of the resolution of the support topic, and the like.

The knowledge base document generation query may also include text content extracted from one or more resources identified in the issue summary or the underlying issue. For example, as noted herein, issues (and optionally their associated issue summaries) may include links to or other identifiers of resources that an agent consulted or found relevant when resolving an issue. Such resources may include information that would be particularly useful in a knowledge base document that is designed to aid in future resolutions of support topic or other issues related to that same product component. Accordingly, text may be extracted from such resources and included in the knowledge base document generation prompt so that the generative service can use that text when generating the knowledge base document. Examples of resources from which text may be extracted for inclusion in the knowledge base document generation prompt include, without limitation, knowledge base documents, webpages, manuals, product specifications and documentation, source code, source code comments, etc. The knowledge base document generation service 230 may extract text from these resources by accessing the resources and extracting some or all of the text content of the resource. In some cases, the knowledge base document generation service 230 may include a semantic extraction engine that selects and extracts text, from the resources, that has a semantic similarity or relationship to other content of the issue. For example, the knowledge base document generation service 230 may vectorize the text of the resource and compare the vector (e.g., using a sliding window technique) against a vectorization of one or more issues or issue summaries associated with the knowledge base document request. The knowledge base document generation service 230 may then include in the prompt a portion of the resource document that satisfies a similarity condition (e.g., based on a cosine similarity analysis) with the issues/issue summaries. The same or similar operation may be implemented for multiple resources. In some cases, instead of extracting only a portion of the text content of a resource document, the entire text of the resource document may be included in the prompt.

Once the knowledge base document generation prompt is generated, the knowledge base document generation service 230 may provide the prompt to a generative service (e.g., the generative service 112, FIG. 1). In response to the prompt, the generative service may return a generative response to the knowledge base document generation service 230, and the knowledge base document generation service 230 may generate at least a portion of a knowledge base document 408 using the generative response. In some cases, the generative response includes text content for the body of the knowledge base document, and the knowledge base document generation service 230 incorporates the text content into a knowledge base document 408 having a particular format, and stores the knowledge base document 408 in the issue tracking platform (e.g., in the knowledge base document data store 210, FIG. 2). In some cases, the knowledge base document generation service 230 includes other information in the generated knowledge base documents. For example, the knowledge base document generation service 230 may incorporate links to or identifiers of underlying issues or issue summaries to which the knowledge base document relates, links to or identifiers of resources on which the knowledge base document was based (e.g., other knowledge base documents, webpages, product manuals, etc.), identifiers of individuals who may be resources for the underlying support topic (e.g., identifiers of other agents who have successfully resolved issues related to the support topic), and the like. The generated knowledge base documents 408 may also include information to facilitate efficient search and retrieval of the knowledge base document, such as identifiers of the particular product component to which the knowledge base document relates, relevant search terms or tags, or the like.

Once the knowledge base document 408 is generated and stored in the issue tracking platform, the knowledge base document may be accessible by other agents or operators of the issue tracking platform. In some cases, the knowledge base documents that are automatically generated by the knowledge base document generation service 230 are submitted for final review, modification (if necessary or desirable), and approval by operators of the issue tracking platform 206. In some cases, the generated knowledge base documents are fully accessible even before they are finally approved. In such cases, the documents may be identified as being under review or pending approval to alert the user to the status of the knowledge base document.

FIGS. 3 and 4 illustrate one example operational flow that may be employed by the knowledge base service 218 to generate knowledge base documents, as described herein. However, different workflows or orders of operation may also be employed. For example, FIG. 4 illustrates the grouping engine 224 and its operations between the issue summarization service 222 and the knowledge base document generation service 230. As described, the grouping engine 224 may be used to identify groups of issue summaries that relate to a same resolution of a same support topic. As shown, this analysis is based on the issue summaries. However, in other examples, the same or similar result may be achieved by analyzing the issues themselves. Thus, for example, the grouping engine 224 may be employed prior to the issue summarization service, such that the issues relating to an issue cluster having a high resource priority score are grouped based on the similarity of their solutions, and the document generation operation 400 proceeds with those issue summaries.

The scoring and document generation operations 300, 400 may be executed multiple times, such as on a cyclic or repeating basis, until knowledge base documents are generated for each issue cluster with resource priority scores that satisfy the evaluation criteria, and for each grouping of similar issues within the issue clusters. For example, FIG. 4 illustrates an issue cluster 402 that includes three separate groups of issue summaries 406-1, 406-2, 406-3, with each issue group determined based on the similarity of the issue summaries. Accordingly, the knowledge base document generation service 230 generates respective knowledge base documents 408-1, 408-2, 408-3 for each respective issue group. In this way, the scoring and document generation operations 300, 400 may be used to quickly identify gaps in knowledge base coverage and generate knowledge base documents to fill those gaps.

FIG. 5 depicts an illustration of a set 500 of resource priority scores 504 for a set of issue clusters 502. The issue clusters 502 may each be related to a respective product component. As described herein, issue clusters 502 may be defined using a grouping engine 224, which may identify semantic similarities between issues based on the issue content. In some cases, issue clusters 502 may be defined using user-supplied tags. For example, agents or operators of the issue tracking platform 206 may manually add tags or other identifiers to issues (e.g., tags identifying product components to which the issue relates), and the clusters 502 may be defined based on the tags.

As described herein, the resource priority scores 504 for each issue cluster may be determined by the scoring engine 220, or any other suitable process or operation. The resource priority scores 504 may be based on various metrics. In some cases, a resource priority score is a weighted combination of multiple metrics.

In some cases, the resource priority scores for an issue cluster (and thus a product component) are based on factors including, but not limited to, on an amount of issues in the issue cluster, an amount of knowledge base documents available in relation to the product component, a relative amount of issues relating to that product component as compared to an overall amount of issues, an amount of time spent by operators working on issues in the issue cluster, a ranking of the knowledge base documents that are associated with the software component and/or issues in the issue cluster (e.g., based on user-generated feedback or votes associated with knowledge base documents), an amount of issues that are marked as resolved (e.g., associated with a workflow state of “resolved” or “completed” that do not have an associated knowledge base document), and the like.

In some cases, an important indicator of a need for knowledge base documents may be that issues are being resolved without reference to any knowledge base document, or without a specific reference to a knowledge base document as a “resolving” document. More particularly, issues may include links to or other identifiers of various resources that were used by an agent during the resolution of an issue. In some cases, certain resources may be separately identified as a “resolving” document, indicating that the resource contained a solution to the issue (and/or information from which the issue can be resolved). If there are many issues relating to the same product component or support topic that do not have associated knowledge base documents and/or do not have an associated “resolving” knowledge base document, that may be a good indication that additional knowledge base documents would be helpful for that particular product component or support topic. Accordingly, the resource priority scores determined by the scoring engine 220 may be based at least in part on an amount of issues that are resolved without reference to a knowledge base document that can be considered a “resolving” document or resource.

These (or other) factors may be weighted relative to one another to determine scores that accurately indicate which product components have the highest need or priority for additional knowledge base documents. The weighting of the various factors may be selected to best reflect the need for additional knowledge base documents for issue clusters. In particular, some factors may be stronger indicia of a need than others, and those factors may be weighted more heavily in the calculation of the resource priority scores 504. For example, the amount of issues that are marked as resolved without an associated knowledge base document (and/or without a “resolving” knowledge base document) may be a strong indicator of a need for knowledge base document, and as such may be more heavily weighted (e.g., it may be the highest weighted factor in the score).

FIG. 5 illustrates example resource priority scores 504 for the issue clusters 502. As shown, the scores are scaled from 0.00-1.00, though this is merely for illustration, and any scoring or scaling scheme may be used. Optionally, the resource priority scores 504 are normalized for a given set of issue clusters.

As described herein, a knowledge base service may select or prioritize issue clusters 502 whose resource priority scores satisfy an evaluation criteria. The evaluation criteria may be fixed, or may be variable based on factors such as the range of resource priority scores for a given set of issue clusters. In the illustrated example, the evaluation criteria 506 corresponds to a resource priority score of 0.50. Thus, issue clusters having resource priority scores greater than 0.50 are selected for generating new knowledge base documents, while those below are not (at least at the illustrated time). Other evaluation criteria may be used to select issue clusters instead of or in addition to a resource priority score value. For example, the evaluation criteria may include the overall rank or position of the issue cluster (e.g., the highest n ranked issue clusters may be selected).

With reference to FIG. 5, the issue clusters 502 with resource priority scores 504 that satisfy the evaluation criteria 506 are selected for further processing. As described herein, in some cases, these issue clusters may be prioritized for knowledge base document generation, and the knowledge base service may also generate knowledge base documents for issue clusters that do not satisfy the evaluation criteria after knowledge base documents for the clusters that did satisfy the criteria have been generated.

Resource priority scores may be updated on an ongoing basis such that the scores can reflect the current state of the issues of the issue tracking platform and of the associated knowledge base. In some cases, the scores are determined cyclically or periodically, such as every day, week, month, or any other suitable frequency (regular or irregular). In some cases, scores are regenerated after a new knowledge base document is generated for an issue cluster. In this way, the new scores can reflect whether the additional document has sufficiently lowered the score of an issue cluster such that it is no longer a priority for further knowledge base documents, or whether that issue is still in need of additional knowledge base documents.

FIG. 6 illustrates an example issue 600 of an issue tracking platform. The issue 600 is shown in a graphical format, such as may be displayed on a frontend graphical user interface of the issue tracking platform, though this is merely for illustration purposes. It will be understood that an issue may take other forms and include less, more, or different content than shown in FIG. 6A.

The issue 600 includes metadata 602. The metadata 602 may include information such as an issue identifier, a date (which may be a creation date, or a collection of dates, such as such as access dates, edit dates, resolved dates, etc.), an agent identifier (e.g., identifying one or more agents or operators who are working on the issue), and issue tags. Issue tags may identify, for example, the product, product component, and support topic of the issue. As described herein, these tags may be assigned by an agent and/or automatically (e.g., by a tagging engine). Further, different issue tags may be selected for the different applications of an issue tracking platform (e.g., they may be based on the particular hierarchy or identification scheme of the product(s) or service(s) supported by an issue tracking platform).

The issue 600 may further include an issue description 604. The issue description 604 may be generated by the agent, and may include a description of the issue that a user is experiencing, steps that the agent has performed to attempt to resolve the issue, and any other suitable information. As described herein, the issue description 604 may be incorporated into a generative prompt for a generative service in order to generate issue summaries, knowledge base documents, and the like.

The issue 600 may further include a communication record 606. The communication record 606 may include transcripts, recordings, summaries, or the like, of communication messages between one or more agents and one or more users associated with the issue. The communication messages may be (or may be extracted from) emails, text messages, chat messages, telephone conversations, or the like. The communication messages may be extracted from the underlying communication form (e.g., chat message, email message, etc.) and incorporated into or otherwise stored in association with the issue (e.g., as fields or attributes of the issue). As described herein, one or more of the communication messages may be extracted from the issue 600 and incorporated into a generative prompt for a generative service in order to generate issue summaries, knowledge base documents, and the like.

The issue 600 may further include a resolution summary 608. The resolution summary 608 may include a textual description of how the issue was resolved, including troubleshooting steps that were performed, a description of how the issue was resolved and/or how to resolve similar issues in the future, or any other information relevant to the resolution of the issue. Resolution summaries may be generated by the agent(s) who have worked on the issue. In some cases, issues that have not been resolved have no resolution summary 608. As described herein, information (e.g., text) from the resolution summary 608 may be extracted from the issue 600 and incorporated into a generative prompt for a generative service in order to generate issue summaries, knowledge base documents, and the like.

The issue 600 may also include a resource list 610 that includes links or other identifiers of resources 612 that were consulted or otherwise deemed useful to the issue. The resources may be selected by the agent, or automatically. For example, an issue tracking platform may pre-select or recommend a set of resources that are associated with the particular product, product component, or issue (e.g., as determined based on the issue tags). Resources may include multiple types of content or content items, such as product manuals, frequently asked questions documents, source code documentation, and knowledge base documents, though these are merely examples, and other resources may also be identified. For issues that are resolved, one or more of the resources may be identified as a resolving document or resource. In some cases, issues may be resolved without resolving documents, in which case the issue record may reflect that no resolving document was available (e.g., the issue may lack a resource identified as a resolving document). As described herein, information (e.g., text) from the resources 612 may be extracted from the resources 612 and incorporated into a generative prompt for a generative service in order to generate issue summaries, knowledge base documents, and the like.

FIG. 6B illustrates an example issue summary 620 that may be generated from an issue, such as by the issue summarization service 222. The issue summary 620 may be generated based at least in part on a generative response from a generative service. For example, content may be extracted from an issue (e.g., the issue description, one or more communication messages, the issue resolution) and incorporated (along with predetermined query prompt text) into an issue summarization prompt. The generative service may provide the issue summary or information that may be incorporated into the issue summary (e.g., text content for the issue summary). As shown in FIG. 6B, the issue summary may include an issue subject 622, which may be a brief description of the issue, support topic, or the like., and the issue summary 624, which may include a substantive description of the underlying support topic and how the support topic can be resolved (or any other information relevant to the support topic). The text of the issue subject 622 and the issue summary 624 may be provided by the generative service in response to the issue summarization prompt.

In some cases, the issue summary 620 may also include a resource list 626 that includes links or other identifiers of resources 612 that were consulted or otherwise deemed useful to the issue that was summarized. Including these resources in the issue summary may allow downstream processes that rely on the issue summary (e.g., knowledge base document generation operations) to access the resources without having to refer to the underlying issue.

While FIG. 6B illustrates one example issue summary 620, the particular contents (and presentation) of the issue summary 620 are merely examples, and issue summaries may include more or different content. For example, in some cases the issue summaries may include a single text field describing the issue and the resolution.

As described herein, issue summaries may be generated for each issue of an issue cluster, and the summaries may be used by the knowledge base service to identify specific support topics for which to generate knowledge base documents, and to ultimately generate the knowledge base documents for that support topic. FIGS. 6C-6D illustrate a group of issue summaries 630 being used as a source of content for a knowledge base document.

As described herein, a knowledge base service may select a group of issue summaries to serve as the basis for a knowledge base document in various ways. For example, the knowledge base service may analyze the issue summaries of an issue cluster to identify a subset of issues that relate to a same resolution of a same support topic (e.g., with a grouping engine, as described with respect to FIG. 4). As another example, the knowledge base service may analyze the issues to identify issues that relate to a same resolution of a same support topic, and then generate issue summaries for that subset of the issues. Further, the group of issue summaries 630 may correspond to a set of issues or issue summaries that were resolved without a resolving document.

Regardless of the technique for selecting the group of issue summaries 630, content may be extracted from the issue summaries 630 and incorporated (along with predetermined query prompt text) into a knowledge base document generation prompt. The content extracted from the issue summaries 630 may include any of the text in the issue summaries, including text that was generated by the generative engine in response to the issue summarization prompt. The extracted content may include, for example, a description of the issue or support topic, troubleshooting steps used in the resolution of the issue, steps used to resolve the issue, descriptions of the product and/or product component to which the support topic relates, descriptions of resources used in resolving the issue, and the like. In some cases, content may also be extracted from the resources identified in the issue summaries (or with reference to the underlying issues). For example, when generating the knowledge base document generation prompt, the knowledge base document generation service may access the resources identified in the resource list, extract content from those resources, and include the extracted content in the knowledge base document generation prompt. Other content may also be included in the prompt, such as content from the underlying issues or any other content accessible by the knowledge base service and/or the issue tracking platform (or other platform or service that the knowledge base service is responsive to).

In response to the knowledge base document generation prompt, the generative service may return a knowledge base document 632, or information from which the knowledge base document 632 is generated (e.g., by the knowledge base document generation service 230). In some cases, the knowledge base document generation prompt specifies the particular type of content or content sections that are to be included in the knowledge base document 632. For example, the knowledge base document generation prompt may specify that the generative response should include a knowledge base document title, a description of the product feature to which the document relates, a description of the support topic(s) or issue(s) to which the document relates, a description of how to resolve the issue, and optionally identifiers of or links to resources that may be helpful in resolving the issue (or that are referred to in the knowledge base document). This (or other) content may be generated by the generative service in response to the knowledge base document generation prompt, and may be incorporated into the knowledge base document 632 by the knowledge base document generation service, and ultimately stored in a knowledge base associated with an issue tracking platform.

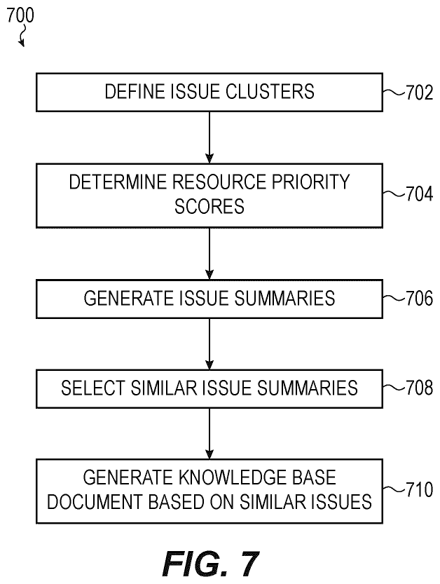

FIG. 7 depicts an example process 700 for generating content for an issue tracking platform. The process 700 may be performed by a knowledge base service, such as the knowledge base service 218, in conjunction with an issue tracking platform, such as the issue tracking platform 206, or any other systems described herein.

At operation 702, a set of issue clusters are defined from a body of issues. The body of issues may be hosted by an issue tracking platform (e.g., the issue tracking platform 206), and each issue cluster may be related to a respective product component. The set of issue clusters may correspond, for example, to the issue clusters 402 in FIG. 4, or any other issue clusters described herein.

At operation 704, resource priority scores are determined for product components (e.g., based on an analysis of the issue clusters for those product components). The resource priority scores may be determined using the techniques described herein, such as with respect to FIG. 5. As described herein, the resource priority scores may be based at least in part on factors such as an amount of issues in the issue cluster, an amount of knowledge base documents available in relation to the product component, an amount of time spent by operators working on issues in the issue cluster, and the like.

At operation 706, a set of issue summaries may be generated. The issue summaries may be generated for the issues of a selected issue cluster based on the resource priority score for that issue cluster satisfying an evaluation criteria. Examples of techniques for selecting an issue cluster for summarization based on the resource priority scores are described herein, such as with respect to FIG. 5.

Issue summaries may be generated as described herein. For example, an issue summarization service 222 of a knowledge base service 218 may generate issue summarizations. The service 222 may use a generative service to generate content for the summaries. For example, the issue summarization service 222 may generate an issue summarization prompt for an issue, where the prompt includes predetermined query prompt text, and first text content extracted from the issue. The prompt may be provided to a generative output engine (e.g., the generative service 112), and a generative response may be received from the generative output engine. The response may be the issue summary or may include information from which the issue summary is generated. Examples of techniques for generating issue summarizations are described herein with respect to FIG. 4, for example.

At operation 708, a group of semantically similar issue summaries may be selected to serve as the basis for a knowledge base document. For example, as described herein, a grouping engine or other service may select a subset of the issue summaries (of an issue cluster) that are semantically similar. This may ensure that the issues and issue summaries that are being used to generate a knowledge base document are directed to the same or similar subject matter, thus resulting in high quality knowledge base documents that are accurate and focused on specific support topics. Examples of techniques for selecting the group of semantically similar issue summaries are described herein with respect to FIG. 4, for example.

At operation 710, a knowledge base document is generated based on the selected issue summaries. Generating the knowledge base document may include generating a knowledge base document generation prompt, providing the prompt to a generative output engine (e.g., the generative service 112), and incorporating the generative response from the generative output engine into a new knowledge base document. As described herein, the knowledge base document prompt may include predetermined query prompt text, and text content extracted from at least a subset of the set of issue summaries. In some cases, the prompt may further include text extracted from a resource document identified in a selected issue summary (or underlying issue). Examples of techniques for generating knowledge base documents are described herein with respect to FIGS. 4-6D, for example.

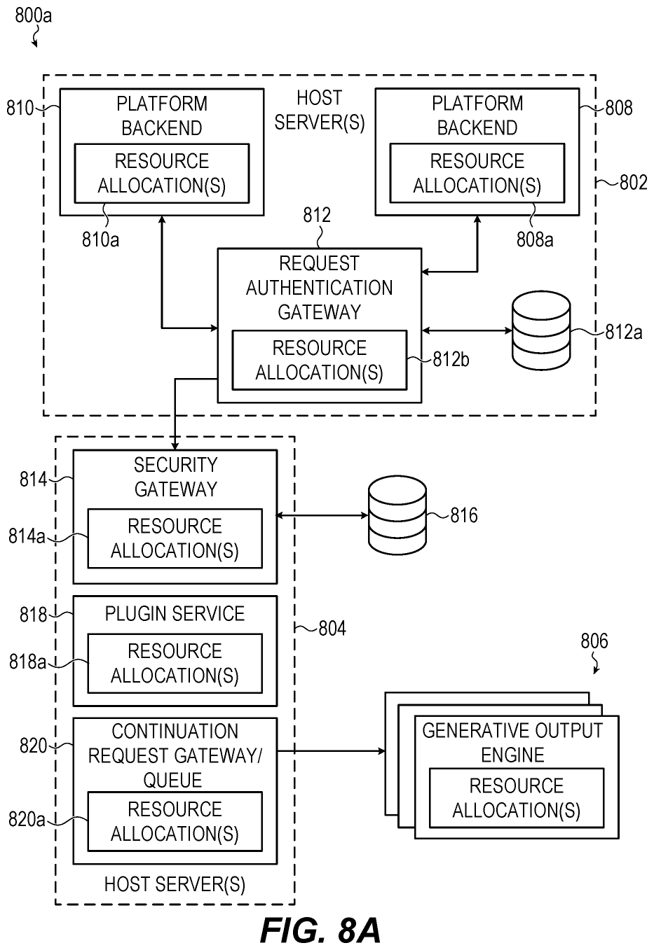

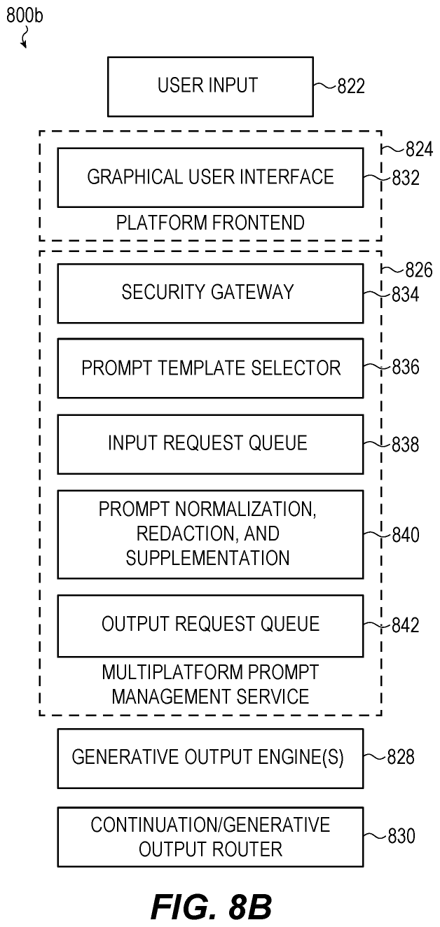

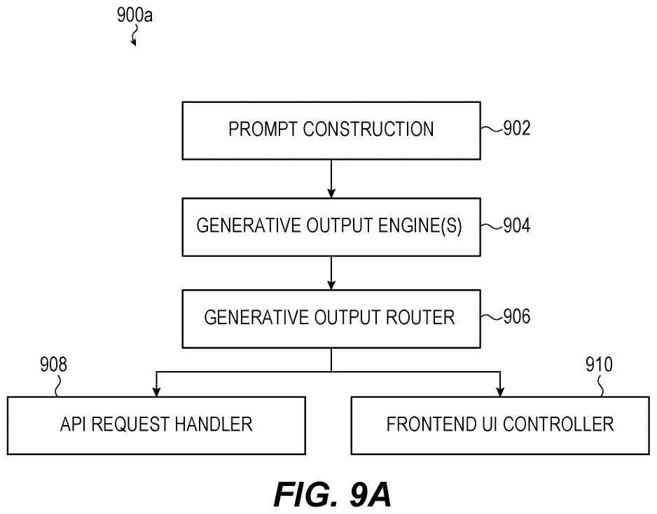

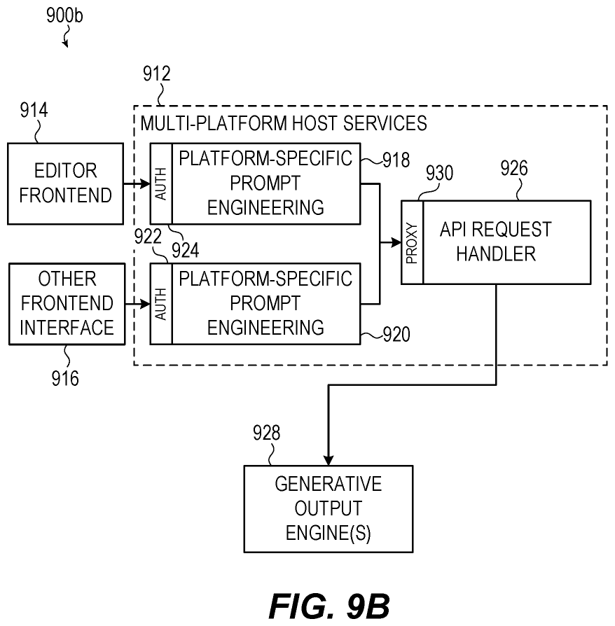

The generative services described herein may be implemented using a networked computing system, as described above with respect to FIG. 1 and other examples, herein. FIGS. 8A-9B describe additional components and functionality that may be used to produce generative content for one or more of the services or engines, as described herein (e.g., the issue summarization service, knowledge base document generation service, etc.). Referring to FIG. 8A, the system 800a includes a first set of host servers 802 associated with one or more software platform backends. These software platform backends can be communicably coupled to a second set of host servers 804 purpose configured to process requests and responses to and from one or more generative output engines 806. Specifically, the first set of host servers 802 (which, as described above can include processors, memory, storage, network communications, and any other suitable physical hardware cooperating to instantiate software) can allocate certain resources to instantiate a first and second platform backend, such as a first platform backend 808 and a second platform backend 810. Each of these respective backends can be instantiated by cooperation of processing and memory resources associated with each respective backend. As illustrated, such dedicated resources are identified as the resource allocations 808a and the resource allocations 810a.

Each of these platform backends can be communicably coupled to an authentication gateway 812 configured to verify, by querying a permissions table, directory service, or other authentication system (represented by the database 812a) whether a particular request for generative output from a particular user or service (e.g., the knowledge base service) is authorized. The authentication gateway 812 may be supported by physical hardware resources, such as a processor and memory, represented by the resource allocations 812b.

Once the authentication gateway 812 determines that a request is authorized to access data or resources implicated in service that request, the request may be passed to a security gateway 814, which may be a software instance supported by physical hardware identified in FIG. 8A as the resource allocations 814a. The security gateway 814 may be configured to determine whether the request itself conforms to one or more policies or rules (data and/or executable representations of which may be stored in a database 816) established by the organization. For example, the organization may prohibit executing prompts for offensive content, value-incompatible content, personally identifying information, health information, trade secret information, unreleased product information, secret project information, and the like. In other cases, a request may be denied by the security gateway 814 if the prompt requests are beyond a threshold quantity of data.

Once a particular prompt has been sufficiently authorized and cleared against organization-specific generative output rules, the request/prompt can be passed to a plugin service 818 configured to populate request-contextualizing data (e.g., user ID, page ID, project ID, URLs, addresses, times, dates, date ranges, and so on), insert the user's request into a larger engineered template prompt and so on. The plugin service 818 may also be referred to as a prompt preconditioning and rehydration service. Example operations of plugin or other preconditioning instance are described elsewhere herein; this description is not repeated. The plugin service 818 can be a software instance supported by physical hardware represented by the resource allocations 818a. In some implementations, the plugin service 818 may also be used to rehydrate personally identifiable information (PII) or other potentially sensitive data that has been extracted from a request or data exchange in the system.

Once a prompt has been modified, replaced, or hydrated by the plugin service 818, it may be passed to an output gateway 820 (also referred to as a continuation gateway or an output queue). The output gateway 820 may be responsible for enqueuing and/or ordering different requests from different users or different software platforms based on priority, time order, or other metrics. The output gateway 820 can also serve to meter requests to the generative output engines 806.

FIG. 8B depicts a functional system diagram of the system 800a depicted in FIG. 8A. In particular, the system 800b is configured to operate as a multiplatform prompt management service supporting and ordering requests from multiple users and/or services across multiple platforms. In particular, a user input 822 (or other request from a service such as the knowledge base service) may be received at a platform frontend 824. The platform frontend 824 passes the input to a prompt management service 826 that formalizes a prompt suitable for input to a generative output engine 828, which in turn can provide its output to an output router 830 that may direct generative output to a suitable destination. All or some of the operations performed by the prompt management service 826 may be performed by a plugin that has been selected from a set of registered plugins based on a context associated with a request and/or an intent analysis performed with respect to a user input.

In one example implementation, the output router 830 may execute API requests generated by the generative output engine 828, may submit text responses back to the platform frontend 824, may wrap a text output of the generative output engine 828 in an API request to update a backend of the platform associated with the platform frontend 824, or may perform other operations. Specifically, the user input 822 (which may be an engagement with a button, typed text input, spoken input, chat box input, and the like) can be provided to a graphical user interface 832 of the platform frontend 824. The graphical user interface 832 can be communicably coupled to a security gateway 834 of the prompt management service 826 that may be configured to determine whether the user input 822 is authorized to execute and/or complies with organization-specific rules. In some cases, the input is received from a service (e.g., the knowledge base service), rather than directly from a user.

The security gateway 834 may provide output to a prompt selector 836 which can be configured to select a prompt template from a database of preconfigured prompts, templatized prompts, or engineered templatized prompts. Once the raw user input is transformed into a string prompt, the prompt may be provided as input to a request queue 838 that orders different user request for input from the generative output engine 828. Output of the request queue 838 can be provided as input to a prompt hydrator 840 configured to populate template fields, add context identifiers, supplement the prompt, and perform other normalization operations described herein. In other cases, the prompt hydrator 840 can be configured to segment a single prompt into multiple discrete requests, which may be interdependent or may be independent. Thereafter, the modified prompt(s) can be provided as input to an output queue at 842 that may serve to meter inputs provided to the generative output engine 828.

These foregoing embodiments depicted in FIGS. 8A-8B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein.

For example, although many constructions are possible, FIG. 9A depicts a simplified system diagram and data processing pipeline as described herein. The system 900a receives input (e.g., inputs from a user or service), and constructs a prompt therefrom at operation 902. After constructing a suitable prompt, and populating template fields, selecting appropriate instructions and examples for an LLM to continue, the modified constructed prompt is provided as input to a generative output engine 904. A continuation from the generative output engine 904 is provided as input to a router 906 configured to classify the output of the generative output engine 904 as being directed to one or more destinations. For example, the router 906 may determine that a particular generative output is an API request that should be executed against a particular API (e.g., such as an API of a system or platform as described herein). In this example, the router 906 may direct the output to an API request handler 908. In another example, the router 906 may determine that the generative output may be suitably directed to a graphical user interface/frontend handled by a frontend UI controller 910. For example, a generative output may include suggestions to be shown to a user below a user's partial input.

Another example architecture is shown in FIG. 9B, illustrating a system providing prompt management, and in particular multiplatform prompt management as a service. The system 900b is instantiated over cloud resources, which may be provisioned from a pool of resources in one or more locations (e.g., datacenters). In the illustrated embodiment, the provisioned resources are identified as the multi-platform host services 912.

The multi-platform host services 912 can receive input from one or more users or services in a variety of ways. For example, some users may provide input via an editor region 914 of a frontend, such as described above. Other users may provide input by engaging with other user interface elements 916 unrelated to common or shared features across multiple platforms. Specifically, the second user may provide input to the multi-platform host services 912 by engaging with one or more platform-specific user interface elements. In yet further examples, one or more frontends or backends (e.g., a knowledge base service) can be configured to automatically generate one or more prompts for continuation by generative output engines as described herein. More generally, in many cases, user input may not be required and prompts may be requested and/or engineered automatically.

The multi-platform host services 912 can include multiple software instances or microservices each configured to receive user inputs and/or proposed prompts and configured to provide, as output, an engineered prompt. In many cases, these instances—shown in the figure as the platform-specific prompt engineering services 918, 920—can be configured to wrap proposed prompts within engineered prompts retrieved from a database such as described above.

In many cases, the platform-specific prompt engineering services 918, 920 can be each configured to authenticate requests received from various sources. In other cases, requests from editor regions or other user interface elements of particular frontends can be first received by one or more authenticator instances, such as the authentication instances 922, 924. In other cases, a single centralized authentication service can provide authentication as a service to each request before it is forwarded to the platform-specific prompt engineering services 918, 920.

Once a prompt has been engineered/supplemented by one of the platform-specific prompt engineering services 918, 920, it may be passed to a request queue/API request handler 926 configured to generate an API request directed to a generative output engine 928 including appropriate API tokens and the engineered prompt as a portion of the body of the API request. In some cases, a service proxy 930 can interpose the platform-specific prompt engineering services 918, 920 and the request queue/API request handler 926, so as to further modify or validate prompts prior to wrapping those prompts in an API call to the generative output engine 928 by the request queue/API request handler 926 although this is not required of all embodiments.

These foregoing embodiments depicted in FIGS. 9A-9B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein.

More generally, it may be appreciated that a multiplatform system as described herein can include a centralized gateway configured to manage requests for generative output across multiple platforms. For example, the centralized gateway (which can precondition prompts, generate prompts, modify prompts, postprocess generative output, handle recursive generative output in which a first generative output is used to produce a second generative output, and so on) can be configured to determine priority of different requests for generative output across multiple systems. For example, certain users or certain roles or certain types of requests for generative output may be prioritized higher by the centralized system and serviced first. In other cases, the centralized system may be configured to rate limit particular users, particular platforms, particular roles, and/or particular request types for a number of suitable reasons (e.g., to comply with generative output system API call limitations, to ensure even treatment across multiple platforms, and so on). In other cases, a centralized gateway can be configured to enforce compliance with one or more policies (e.g., policies limiting particular kinds of generative output, policies for information sharing, personal information dissemination policies, and so on). In yet other cases, a centralized gateway can be used to manage or load balance between multiple different LLMs.

More generally, it may be appreciated that a system as described herein can be used for a variety of purposes and functions to enhance functionality of collaboration tools. Detailed examples follow. Similarly, it may be appreciated that systems as described herein can be configured to operate in a number of ways, which may be implementation specific.

For example, it may be appreciated that information security and privacy can be protected and secured in a number of suitable ways. For example, in some cases, a single generative output engine or system may be used by a multiplatform collaboration system as described herein. In this architecture, authentication, validation, and authorization decisions in respect of business rules regarding requests to the generative output engine can be centralized, ensuring auditable control over input to a generative output engine or service and auditable control over output from the generative output engine. In some constructions, authentication to the generative output engine's services may be checked multiple times, by multiple services or service proxies. In some cases, a generative output engine can be configured to leverage different training data in response to differently-authenticated requests. In other cases, unauthorized requests for information or generative output may be denied before the request is forwarded to a generative output engine, thereby protecting tenant-owned information within a secure internal system. It may be appreciated that many constructions are possible.

Additionally, some generative output engines can be configured to discard input and output once a request has been serviced, thereby retaining zero data. Such constructions may be useful to generate output in respect of confidential or otherwise sensitive information. In other cases, such a configuration can enable multi-tenant use of the same generative output engine or service, without risking that prior requests by one tenant inform future training that in turn informs a generative output provided to a second tenant. Broadly, some generative output engines and systems can retain data and leverage that data for training and functionality improvement purposes, whereas other systems can be configured for zero data retention.

In some cases, requests may be limited in frequency, total number, or in scope of information requestable within a threshold period of time. These limitations (which may be applied on the user level, role level, tenant level, product level, and so on) can prevent monopolization of a generative output engine (especially when accessed in a centralized manner) by a single requester. Other conditions or controls may also be applied to the system in order to facilitate reliable and consistent usage of shared resources.

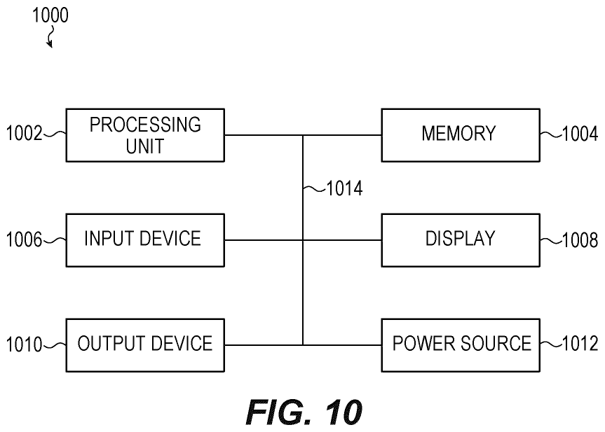

FIG. 10 shows a sample electrical block diagram of an electronic device 1000 that may perform the operations described herein. The electronic device 1000 may in some cases take the form of any of the electronic devices described with reference to any of the preceding figures and examples, including client devices, and/or servers or other computing devices associated with the systems described herein. The electronic device 1000 can include one or more of a processing unit 1002, a memory 1004 or storage device, input devices 1006, a display 1008, output devices 1010, and a power source 1012. In some cases, various implementations of the electronic device 1000 may lack some or all of these components and/or include additional or alternative components.

The processing unit 1002 can control some or all of the operations of the electronic device 1000. The processing unit 1002 can communicate, either directly or indirectly, with some or all of the components of the electronic device 1000. For example, a system bus or other communication mechanism 1014 can provide communication between the processing unit 1002, the power source 1012, the memory 1004, the input device(s) 1006, and the output device(s) 1010.

The processing unit 1002 can be implemented as any electronic device capable of processing, receiving, or transmitting data or instructions. For example, the processing unit 1002 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1000 can be controlled by multiple processing units. For example, select components of the electronic device 1000 (e.g., an input device 1006) may be controlled by a first processing unit and other components of the electronic device 1000 (e.g., the display 1008) may be controlled by a second processing unit, where the first and second processing units may or may not be in communication with each other.

The power source 1012 can be implemented with any device capable of providing energy to the electronic device 1000. For example, the power source 1012 may be one or more batteries or rechargeable batteries. Additionally, or alternatively, the power source 1012 can be a power connector or power cord that connects the electronic device 1000 to another power source, such as a wall outlet.

The memory 1004 can store electronic data that can be used by the electronic device 1000. For example, the memory 1004 can store electronic data or content such as, for example, audio and video files, documents and applications, device settings and user preferences, timing signals, control signals, and data structures or databases. The memory 1004 can be configured as any type of memory. By way of example only, the memory 1004 can be implemented as random access memory, read-only memory, flash memory, removable memory, other types of storage elements, or combinations of such devices.

In various embodiments, the display 1008 provides a graphical output, for example associated with an operating system, user interface, and/or applications of the electronic device 1000 (e.g., a chat user interface, an issue-tracking user interface, an issue-discovery user interface, etc.). In one embodiment, the display 1008 includes one or more sensors and is configured as a touch-sensitive (e.g., single-touch, multi-touch) and/or force-sensitive display to receive inputs from a user. For example, the display 1008 may be integrated with a touch sensor (e.g., a capacitive touch sensor) and/or a force sensor to provide a touch-and/or force-sensitive display. The display 1008 is operably coupled to the processing unit 1002 of the electronic device 1000.

The display 1008 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 1008 is positioned beneath and viewable through a cover that forms at least a portion of an enclosure of the electronic device 1000.

In various embodiments, the input devices 1006 may include any suitable components for detecting inputs. Examples of input devices 1006 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 1006 may be configured to detect one or more particular types of input and provide a signal (e.g., an input signal) corresponding to the detected input. The signal may be provided, for example, to the processing unit 1002.

As discussed above, in some cases, the input device(s) 1006 include a touch sensor (e.g., a capacitive touch sensor) integrated with the display 1008 to provide a touch-sensitive display. Similarly, in some cases, the input device(s) 1006 include a force sensor (e.g., a capacitive force sensor) integrated with the display 1008 to provide a force-sensitive display.

The output devices 1010 may include any suitable components for providing outputs. Examples of output devices 1010 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device 1010 may be configured to receive one or more signals (e.g., an output signal provided by the processing unit 1002) and provide an output corresponding to the signal.

In some cases, input devices 1006 and output devices 1010 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1002 may be operably coupled to the input devices 1006 and the output devices 1010. The processing unit 1002 may be adapted to exchange signals with the input devices 1006 and the output devices 1010. For example, the processing unit 1002 may receive an input signal from an input device 1006 that corresponds to an input detected by the input device 1006. The processing unit 1002 may interpret the received input signal to determine whether to provide and/or change one or more outputs in response to the input signal. The processing unit 1002 may then send an output signal to one or more of the output devices 1010, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes, at a minimum, one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

What is claimed is:

1. A computer-implemented method of generating content for an issue tracking platform, the method comprising:
defining a set of issue clusters from a body of issues, the body of issues hosted by the issue tracking platform, each issue cluster related to a respective product component;
analysing an issue cluster of the set of issue clusters to determine a resource priority score for a particular product component;
in response to the resource priority score satisfying an evaluation criteria, generating a set of issue summaries from a set of issues, the set of issues corresponding to the particular product component, wherein generating an issue summary for a particular issue of the set of issues comprises:
generating an issue summarization prompt for the particular issue, the issue summarization prompt comprising:
predetermined first query prompt text; and
first text content extracted from the particular issue;
providing the issue summarization prompt to a generative output engine;
receiving a first generative response from the generative output engine; and
generating the issue summary for the particular issue using the first generative response;
generating a knowledge base document generation prompt, the knowledge base document generation prompt comprising:
second predetermined query prompt text; and
second text content extracted from at least a subset of the set of issue summaries;
providing the knowledge base document generation prompt to the generative output engine;
receiving a second generative response from the generative output engine; and
generating at least a portion of a knowledge base document using the second generative response and storing the knowledge base document in the issue tracking platform.

2. The computer-implemented method of claim 1, wherein:
the method further comprises, prior to generating the knowledge base document, selecting a group of issue summaries from the set of issue summaries, the selection based at least in part on a semantic similarity of the issue summaries of the group of issue summaries; and
the second text content extracted from the at least the subset of the set of issue summaries is extracted from the issue summaries of the group of issue summaries.

3. The computer-implemented method of claim 2, wherein the selection of the group of issue summaries is further based on a determination that the issue summaries of the group of issue summaries are not associated with any knowledge base document in the issue tracking platform.

4. The computer-implemented method of claim 1, wherein the resource priority score for the product component is based at least in part on an amount of issues in the issue cluster and an amount of knowledge base documents available in relation to the product component.

5. The computer-implemented method of claim 4, wherein the resource priority score for the product component is further based at least in part on an amount of time spent by operators working on issues in the issue cluster.

6. The computer-implemented method of claim 1, wherein the first text content extracted from the at least the subset of the set of issues comprises a communication message extracted from an issue.

7. The computer-implemented method of claim 6, wherein:
the issue is associated with an identifier of a resource document that contains information relevant to the issue; and
the knowledge base document generation prompt further comprises third text content extracted from the resource document.

8. A computer-implemented method of generating content for an issue tracking platform, the method comprising:
defining a set of issue clusters from a body of issues, the body of issues hosted by the issue tracking platform, each issue cluster related to a respective product component;
analysing an issue cluster of the set of issue clusters to determine a resource priority score for a product component, the resource priority score based at least in part on:
an amount of issues in the issue cluster; and
an amount of knowledge base documents available in relation to the product component;
in response to the resource priority score satisfying an evaluation criteria, generating a set of issue summaries from each of a set of issues, the set of issues corresponding to the product component, wherein generating an issue summary for a particular issue of the set of issues comprises:
generating an issue summarization prompt for the particular issue, the issue summarization prompt comprising:
predetermined query prompt text; and
an issue description and one or more communication messages extracted from the particular issue;
providing the issue summarization prompt to a generative output engine;
receiving a first generative response from the generative output engine, the first generative response including the issue summary; and
generating the issue summary for the particular issue using the first generative response;
selecting a group of issue summaries from the set of issue summaries, the selection based at least in part on a semantic similarity of the issue summaries of the group of issue summaries; and
generating a knowledge base document for the product component based on the group of issue summaries, comprising:
generating a knowledge base document generation prompt;
providing the knowledge base document generation prompt to the generative output engine; and
receiving a second generative response from the generative output engine; and
generating at least a portion of the knowledge base document using the second generative response and storing the knowledge base document in the issue tracking platform.

9. The computer-implemented method of claim 8, wherein:
the predetermined query prompt text is first predetermined query prompt text; and
the knowledge base document generation prompt includes:
second predetermined query prompt text; and
text content extracted from at least a subset of the group of issue summaries.

10. The computer-implemented method of claim 9, wherein:
at least one issue represented by an issue summary of the group of issue summaries is associated with an identifier of a resource document that contains information relevant to the at least one issue; and
the knowledge base document generation prompt further comprises third text content extracted from the resource document.

11. The computer-implemented method of claim 8, wherein:
the group of issue summaries is a first group of issue summaries;
the knowledge base document is a first knowledge base document; and
the method further comprises:
selecting a second group of issue summaries from the set of issue summaries, the selection based at least in part on a semantic similarity of the issue summaries of the second group of issue summaries; and
generating a second knowledge base document for the product component based on the second group of issue summaries.

12. The computer-implemented method of claim 8, wherein:
selecting the group of issue summaries from the set of issue summaries comprises:
generating respective content vectors for respective issue summaries of the set of issue summaries; and
selecting, as the group of issue summaries, issue summaries with content vectors that satisfy a semantic similarity condition.

13. The computer-implemented method of claim 8, wherein the respective product component is a software feature of a software application.

14. The computer-implemented method of claim 8, wherein:
the issue cluster of the set of issue clusters includes issues associated with a resolved issue status; and
at least a subset of the issues associated with the resolved issue status are not associated with any knowledge base document in the issue tracking platform.

15. A computer system comprising:
one or more processors;
memory; and
one or more programs stored in the memory and configured to be executed by the one or more processors and including instructions for:
analysing an issue cluster of a set of issue clusters of an issue tracking platform to determine a resource priority score for a particular product component, each issue cluster related to a respective product component;
in response to the resource priority score satisfying an evaluation criteria, generating a set of issue summaries from a set of issues, the set of issues corresponding to the particular product component;
extracting first text content from a resource document identified in at least one issue of the set of issues corresponding to the product component;
extracting second text content from at least a subset of the set of issue summaries;
generating a knowledge base document generation prompt, the knowledge base document generation prompt comprising:
predetermined query prompt text;
the first text content extracted from the resource document; and
the second text content extracted from the at least the subset of the set of issue summaries;
providing the knowledge base document generation prompt to the generative output engine;
receiving a generative response from the generative output engine; and
generating at least a portion of a knowledge base document using the generative response and storing the knowledge base document in the issue tracking platform.

16. The computer system of claim 15, wherein:
the one or more programs further include instructions for, prior to generating the knowledge base document, selecting a group of issue summaries from the set of issue summaries, the selection based at least in part on a semantic similarity of the issue summaries of the group of issue summaries; and
the second text content extracted from the at least the subset of the set of issue summaries is extracted from the issue summaries of the group of issue summaries.

17. The computer system of claim 15, wherein:
the generative response is a first generative response; and
generating an issue summary for a particular issue of the set of issues comprises:
generating an issue summarization prompt for the particular issue, the issue summarization prompt comprising third text content extracted from the particular issue;
providing the issue summarization prompt to a generative output engine;
receiving a second generative response from the generative output engine; and
generating the issue summary for the particular issue using the second generative response.

18. The computer system of claim 15, wherein the resource priority score for the product component is based at least in part on an amount of issues in the issue cluster and an amount of knowledge base documents available in relation to the product component.

19. The computer system of claim 18, wherein the resource priority score for the product component is further based at least in part on an amount of time spent by operators working on issues in the issue cluster.

20. The computer system of claim 15, wherein the second text content extracted from the at least the subset of the set of issues comprises a communication message extracted from an issue.
